(19) United States
(12) Patent Application Publication
(10) Pub. No.: US 2025/0215823 A1
(43) Pub. Date: Jul. 3, 2025

(54) GAS TURBINE ENGINE

(71) Applicant: General Electric Company, Evendale, OH (US)

(72) Inventors: Daniel Alan Niergarth, Norwood, OH (US); Jeffrey Donald Clements, Mason, OH (US); Jeffrey S. Spruill, Hillsboro, OH (US); Erich Alois Krammer, West Chester, OH (US); Matthew Kenneth MacDonald, Austin, TX (US); Scott Alan Schimmels, Miamisburg, OH (US); Paul Hadley Vitt, Liberty Township, OH (US)

(21) Appl. No.: 19/083,161

(22) Filed: Mar. 18, 2025

Related U.S. Application Data
(63) Continuation-in-part of application No. 18/481,515, filed on Oct. 5, 2023.
Application No. 18/481,515 is a continuation-in-part of application No. 17/978,629, filed on Nov. 1, 2022, now abandoned.

(51) Int. Cl. F02C 3/06

(52) U.S. Cl. CPC F02C 3/06; F05D 2200/12; F05D 2200/13; F05D 2200/14; F05D 2200/211; F05D 2200/221; F05D 2240/128

(57) ABSTRACT

A gas turbine engine is provided. The gas turbine engine includes: a turbomachine having a compressor section, a combustion section, and a turbine section arranged in serial flow order, the compressor section having a high pressure compressor defining a high pressure compressor exit area (A_{HPCExit}) in square inches; wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific determined as follows: Fn_{Total}×EGT/(A_{HPCExit}²×1000).

### CROSS-REFERENCE TO RELATED APPLICATIONS

This application is a continuation-in-part application of U.S. application Ser. No. 18/481,515 filed Oct. 5, 2023, which is a continuation-in-part application of U.S. application Ser. No. 17/978,629 filed Nov. 1, 2022. Each of these applications are hereby incorporated by reference in their entirety.

### FIELD

The present disclosure relates to a gas turbine engine.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended FIGS., in which:

FIG. 1 is a schematic cross-sectional view of a three-stream engine in accordance with an exemplary embodiment of the present disclosure.

FIG. 2 is a close-up, schematic view of the exemplary three-stream engine of FIG. 1 with a cooled cooling air system in accordance with an exemplary embodiment of the present disclosure.

FIG. 3 is a close-up view of an aft-most stage of high pressure compressor rotor blades within the exemplary three-stream engine of FIG. 1.

FIG. 4 is a close-up, schematic view of the exemplary three-stream engine of FIG. 1 showing the cooled cooling air system of FIG. 2.

FIG. 5 is a schematic view of a thermal transport bus of the present disclosure.

FIG. 6 is a table depicting numerical values showing the relationships between various parameters in accordance with various example embodiments of the present disclosure.

FIG. 7 is a graph depicting a range of corrected specific thrust values and redline exhaust gas temperature values of gas turbine engines in accordance with various example embodiments of the present disclosure.

FIG. 8 is a schematic view of a ducted turbofan engine in accordance with an exemplary aspect of the present disclosure.

FIG. 9 is a schematic, close-up view of a gas turbine engine having a cooled cooling air system in accordance with another exemplary aspect of the present disclosure.

FIG. 10 is a schematic, close-up view of a gas turbine engine having a cooled cooling air system in accordance with yet another exemplary aspect of the present disclosure.

FIG. 11 is a schematic, close-up view of a gas turbine engine having a cooled cooling air system in accordance with still another exemplary aspect of the present disclosure.

FIG. 12 is a schematic view of a turbofan engine in accordance with another exemplary aspect of the present disclosure.

FIG. 13 is a schematic cross-sectional view of a gas turbine engine according to an exemplary aspect of the present disclosure.

FIG. 14 is a schematic cross-sectional view illustrating a portion of the gas turbine engine according to an exemplary aspect of the present disclosure.

FIG. 15 is a perspective view of an exemplary first stage turbine nozzle, illustrating a general structure in which an exemplary aspect of the present disclosure can be implemented.

FIG. 16 is a schematic diagram of a vane assembly according to an exemplary aspect of the present disclosure.

FIG. 17 is a cross-section top-down view of a portion of the first stage turbine nozzle of FIG. 15, illustrating two vanes or airfoils according to an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The term “cooled cooling air system” is used herein to mean a system configured to provide a cooling airflow to one or more components exposed to a working gas flowpath of a turbomachine of a gas turbine engine at a location downstream of a combustor of the turbomachine and upstream of an exhaust nozzle of the turbomachine, the cooling airflow being in thermal communication with a heat exchanger for reducing a temperature of the cooling airflow at a location upstream of the one or more components.

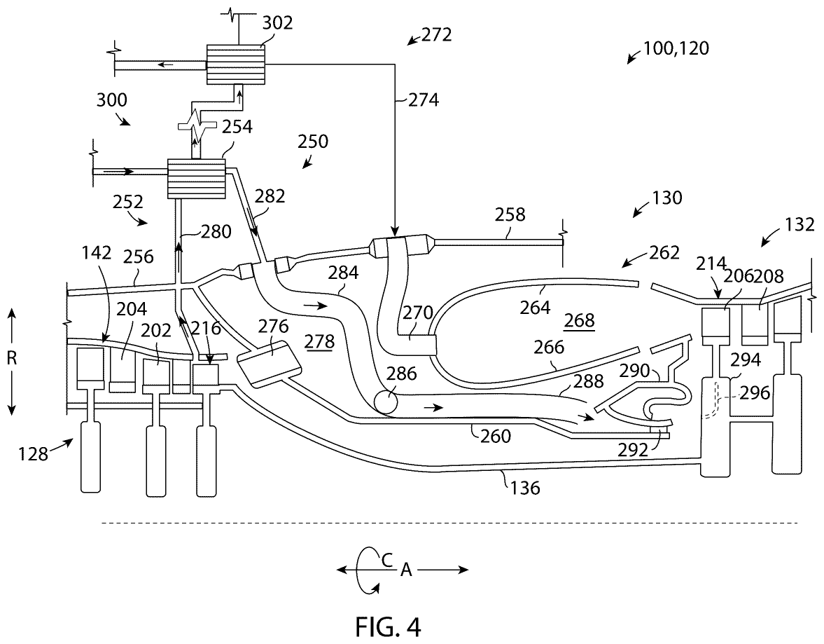

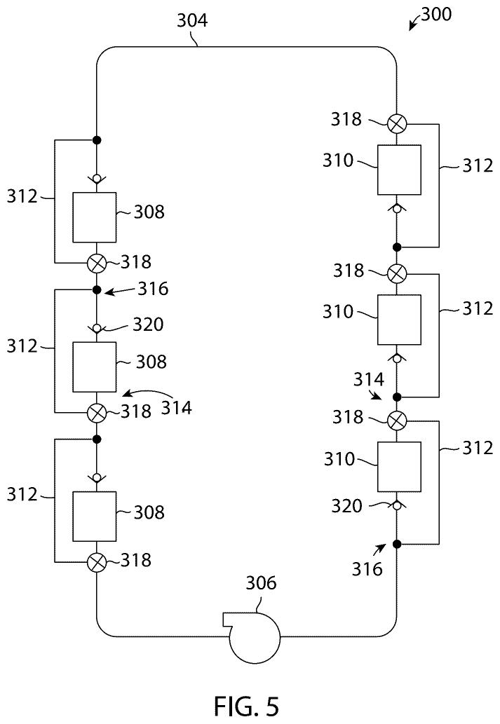

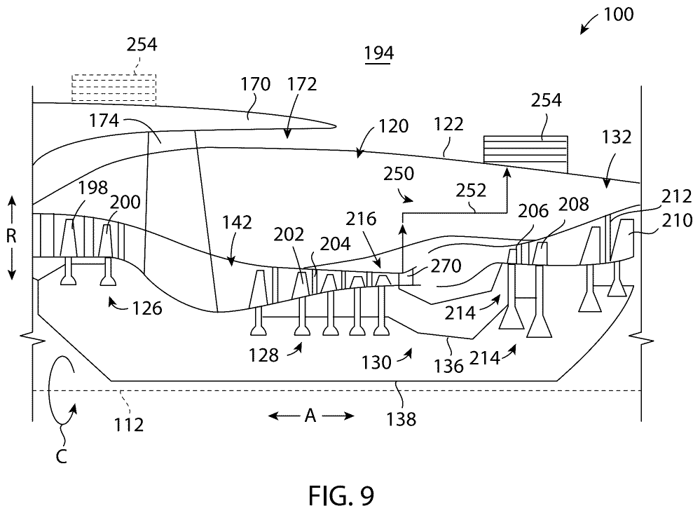

The cooled cooling air systems contemplated by the present disclosure may include a thermal bus cooled cooling air system (see, e.g., FIGS. 4 and 5) or a dedicated heat exchanger cooled cooling air system (i.e., a cooled cooling air system including a heat sink heat exchanger dedicated to the cooled cooling air system); a bypass heat exchanger cooled cooling air system having a heat sink heat exchanger thermally coupled to an airflow through a bypass passage (see, e.g., FIG. 9); an air-to-air cooled cooling air system (i.e., a cooled cooling air system having a heat sink heat exchanger configured to transfer heat to an airflow; see, e.g., FIG. 9); an oil-to-air cooled cooling air system (i.e., a cooled cooling air system having a heat sink heat exchanger configured to transfer heat to an oil flow); a fuel-to-air cooled cooling air system (i.e., a cooled cooling air system having a heat sink heat exchanger configured to transfer heat to a fuel flow, such as a Jet A fuel flow, a liquid hydrogen or hydrogen gas fuel flow, etc.; see, e.g., FIG. 4); or a combination thereof.

In one or more of the exemplary cooled cooling air systems described herein, the cooled cooling air system may receive the cooling air from a downstream end of a high pressure compressor (i.e., a location closer to a last stage of the high pressure compressor), an upstream end of the high pressure compressor (i.e., a location closer to a first stage of the high pressure compressor), a downstream end of a low pressure compressor (i.e., a location closer to a last stage of the low pressure compressor), an upstream end of the low pressure compressor (i.e., a location closer to a first stage of the low pressure compressor), a location between compressors, a bypass passage, a combination thereof, or any other suitable airflow source.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The phrases “from X to Y” and “between X and Y” each refers to a range of values inclusive of the endpoints (i.e., refers to a range of values that includes both X and Y).

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “takeoff power level” refers to a power level of a gas turbine engine used during a takeoff operating mode of the gas turbine engine during a standard day operating condition.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

As used herein, the term “set” or a “set” of elements can be any number of elements, including only one.

The term “fluid” may be a gas or a liquid, or multi-phase. The term “fluid communication” means that a fluid is capable of making the connection between the areas specified.

Additionally, as used herein, the terms “radial” or “radially” refer to a dimension away from a common center. For example, in the overall context of a turbine engine, radial refers to a direction along a ray extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein.

Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary.

The term “overall pressure ratio” (OPR), or overall compression ratio, as used herein, is a ratio of a total pressure immediately downstream of a last stage of a compressor section of a turbine engine to a total pressure immediately upstream of an inlet of the fan section. The OPR can be determined based on a predetermined thrust of the gas turbine engine, such as a nameplate rated thrust.

The term “airfoil” as used herein, refers to a structure having a cross-sectional shape that provides a reactive aerodynamic force when in motion relative to the surrounding air.

In some examples, an aerodynamic performance of a turbine nozzle refers to the relative ability of the turbine nozzle to effectively aerodynamically condition or redirect an axial airflow to a circumferential airflow, and accelerate the airflow toward a rotational speed of a corresponding blade.

The term “chord length”, or “CL”, as used herein, refers to a straight-line length between a leading edge of an airfoil and a trailing edge of the airfoil.

The term “axial chord length”, or “CLa”, as used herein, refers to a straight-line length along an axial direction of airflow between the leading edge of the airfoil and the trailing edge of the airfoil.

The term “pitch”, or “P”, as used herein, refers to a circumferential distance or gap between leading edges of adjacent airfoils. The circumferential distance is measurable at any common radial distance from the engine centerline, but is generally measured at the mid-point of the span of the airfoil.

The term “solidity”, or “o”, as used herein, is the ratio of the axial chord length (CLa) to the pitch (P).

The term “NOx Dp/Foo” as used herein is the gaseous emissions mass in grams (Dp) of oxides of nitrogen (NOx) emitted by the gas turbine engine, divided by the rated output (Foo) of the engine in kilonewtons.

The term “Dp/Foo Ratio” (DPFR) is a ratio of a NOx Dp/Foo value of a new design gas turbine engine to the NOx Dp/Foo value for any predecessor turbine engine.

The term “turbine blade leading hub radius” (Rt) as used herein is a distance from a first turbine blade hub at a leading edge of a corresponding blade of a gas turbine engine to a centerline of the engine.

The term “core radius ratio” (CRR) as used herein is a ratio of the turbine blade leading hub radius Rt to the inner radius R_{INNER}.

The term “number of turbine stages” (N) is an integer number of sequentially arranged rotor/stator turbine stages of a gas turbine engine.

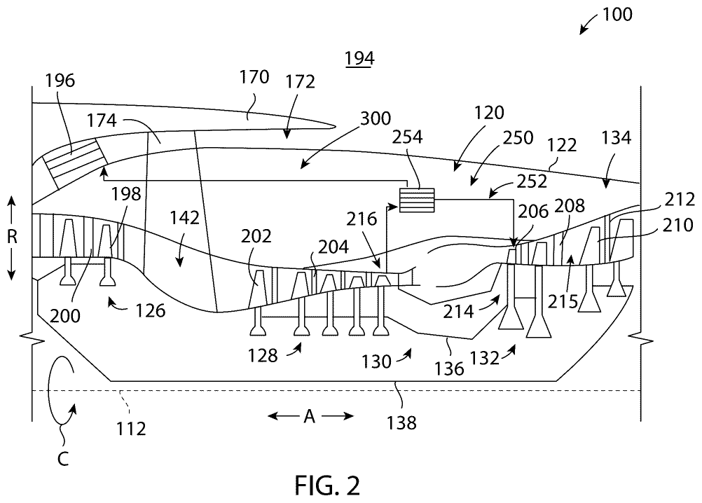

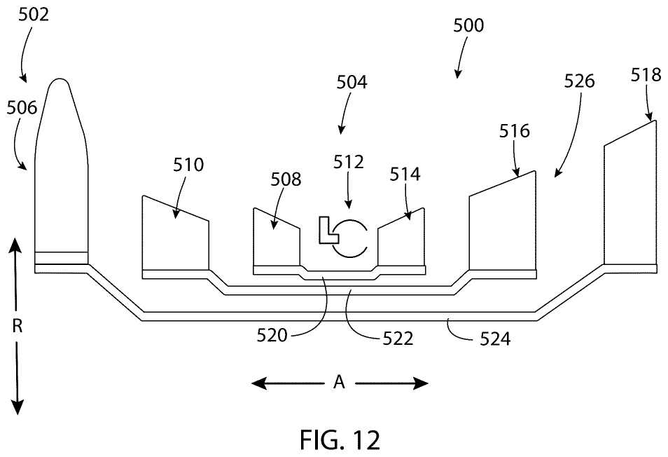

The term redline exhaust gas temperature (referred to herein as “redline EGT”) refers to a maximum permitted takeoff temperature documented in a Federal Aviation Administration (“FAA”)-type certificate data sheet. For example, in certain exemplary embodiments, the term redline EGT may refer to a maximum permitted takeoff temperature of an airflow after a first stage stator downstream of an HP turbine of an engine that the engine is rated to withstand. For example, with reference to the exemplary engine 100 discussed below with reference to FIG. 2, the term redline EGT refers to a maximum permitted takeoff temperature of an airflow after the first stator 208 downstream of the last stage of rotor blades 206 of the HP turbine 132 (at location 215 into the first of the plurality of LP turbine rotor blades 210). In embodiments wherein the engine is configured as a three spool engine (as compared to the two spool engine of FIG. 2; see FIG. 12), the term redline EGT refers to a maximum permitted takeoff temperature of an airflow after the first stator downstream of the last stage of rotor blades of the intermediate speed turbine (see intermediate speed turbine 516 of the engine 500 of FIG. 12). The term redline EGT is sometimes also referred to as an indicated turbine exhaust gas temperature or indicated turbine temperature.

Generally, a turbofan engine includes a fan and a turbomachine, with the turbomachine rotating the fan to generate thrust. The turbomachine includes a compressor section, a combustion section, a turbine section, and an exhaust section and defines a working gas flowpath therethrough. A relatively small amount of thrust may also be generated by an airflow exiting the working gas flowpath of the turbomachine through the exhaust section. In addition, certain turbofan engines may further include a third stream that contributes to a total thrust output of the turbofan engine, potentially allowing for a reduction in size of a core of the turbomachine for a given total turbofan engine thrust output.

Conventional turbofan engine design practice has limited a compressor pressure ratio based at least in part on the gas temperatures at the exit stage of a high pressure compressor. These relatively high temperatures at the exit of the high pressure compressor may also be avoided when they result in prohibitively high temperatures at an inlet to the turbine section, as well as when they result in prohibitively high exhaust gas temperatures through the exhaust section. For a desired turbofan engine thrust output produced from an increased pressure ratio across the high pressure compressor, there is an increase in the gas temperature at the compressor exit, at a combustor inlet, at the turbine section inlet, and through an exhaust section of the turbofan engine.

The inventors have recognized that there are generally three approaches to making a gas turbine engine capable of operating at higher temperatures while providing a net benefit to engine performance: reducing the temperature of a gas used to cool core components, utilizing materials capable of withstanding higher operating temperature conditions, or a combination thereof.

Referring to the case of an engine that utilizes cooled cooling air for operating at higher temperatures, the inventors of the present disclosure discovered, unexpectedly, that the costs associated with achieving a higher compression by reducing gas temperatures used to cool core components to accommodate higher core gas temperatures may indeed produce a net benefit, contrary to prior expectations in the art. The inventors discovered during the course of designing several engine architectures of varying thrust classes and mission requirements (including the engines illustrated and described in detail herein) a relationship exists among the exhaust gas passing through the exhaust section, the desired maximum thrust for the engine, and the size of the exit stage of the high pressure compressor, whereby including this technology produces a net benefit. Previously it was thought that the cost for including a technology to reduce the temperature of gas intended for cooling compressor and turbine components was too prohibitive, as compared to the benefits of increasing the core temperatures.

For example, the inventors of the present disclosure found that a cooled cooling air system may be included while maintaining or even increasing the maximum turbofan engine thrust output, based on this discovery. The cooled cooling air system may receive an airflow from the compressor section, reduce a temperature of the airflow using a heat exchanger, and provide the cooled airflow to one or more components of the turbine section, such as a first stage of high pressure turbine rotor blades. In such a manner, a first stage of high pressure turbine rotor blades may be capable of withstanding increased temperatures by using the cooled cooling air, while providing a net benefit to the turbofan engine, i.e., while taking into consideration the costs associated with accommodations made for the system used to cool the cooling air.

The inventors reached this conclusion after evaluating potentially negative impacts to engine performance brought on by introduction of a cooled cooling air system. For example, a cooled cooling air system may generally include a duct extending through a diffusion cavity between a compressor exit and a combustor within the combustion section, such that increasing the cooling capacity may concomitantly increase a size of the duct and thus increase a drag or blockage of an airflow through the diffusion cavity, potentially creating problems related to, e.g., combustor aerodynamics. Similarly, a dedicated or shared heat exchanger of the cooled cooling air system may be positioned in a bypass passage of the turbofan engine, which may create an aerodynamic drag or may increase a size of the shared heat exchanger and increase aerodynamic drag. Size and weight increases associated with maintaining certain risk tolerances were also taken into consideration. For example, a cooled cooling air system must be accompanied with adequate safeguards in the event of a burst pipe condition, which safeguards result in further increases in the overall size, complexity, and weight of the system.

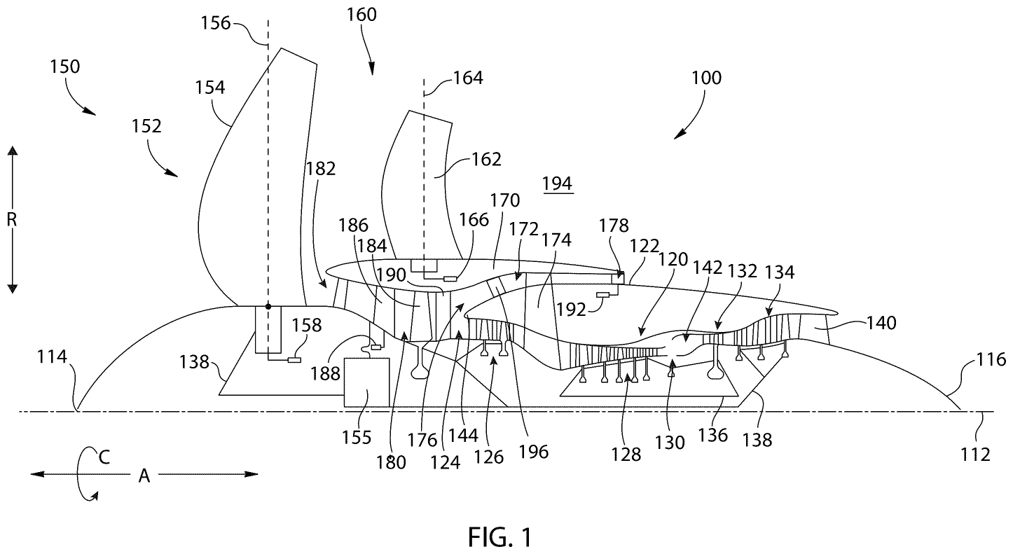

With a goal of arriving at an improved turbofan engine capable of operating at higher temperatures at the compressor exit and turbine inlet, the inventors have proceeded in the manner of designing turbofan engines having an overall pressure ratio, total thrust output, redline exhaust gas temperature, and the supporting technology characteristics; checking the propulsive efficiency and qualitative turbofan engine characteristics of the designed turbofan engine; redesigning the turbofan engine to have higher or lower compression ratios based on the impact on other aspects of the architecture, total thrust output, redline exhaust gas temperature, and supporting technology characteristics; rechecking the propulsive efficiency and qualitative turbofan engine characteristics of the redesigned turbofan engine; etc. during the design of several different types of turbofan engines, including the turbofan engines described below with reference to FIGS. 1 and 4 through 8 through 11, which will now be discussed in greater detail.

Referring now to FIG. 1, a schematic cross-sectional view of an engine 100 is provided according to an example embodiment of the present disclosure. Particularly, FIG. 1 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 1 includes a third stream extending from a location downstream of a ducted mid-fan to a bypass passage over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section 130, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor of the combustion section 130 where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustion section 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustion section 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The working gas flowpath 142 is an annular duct positioned generally inward of the core cowl 122 along the radial direction R. The working gas flowpath 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween, and further defines a central blade axis 156. For this embodiment, each fan blade 154 of the fan 152 is rotatable about its respective central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170. Notably, the engine 100 defines a bypass passage 194 over the fan cowl 170 and core cowl 122.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan 152. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan duct flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the working gas flowpath 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the working gas flowpath 142 may at least partially co-extend (generally axially) on opposite sides (e.g., opposite radial sides) of the core cowl 122. For example, the fan duct 172 and the working gas flowpath 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the working gas flowpath 142 and the fan duct 172 by the leading edge 144 of the core cowl 122. The inlet duct 180 is wider than the working gas flowpath 142 along the radial direction R. The inlet duct 180 is also wider than the fan duct 172 along the radial direction R. The secondary fan 184 is positioned at least partially in the inlet duct 180.

Notably, for the embodiment depicted, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vane 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vane 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb as well as cruise.

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 196 may be positioned in thermal communication with the fan duct 172. For example, one or more heat exchangers 196 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 196 may be an annular heat exchanger extending substantially 360 degrees in the fan duct 172 (e.g., at least 300 degrees, such as at least 330 degrees). In such a manner, the heat exchanger 196 may effectively utilize the air passing through the fan duct 172 to cool one or more systems of the engine 100 (e.g., a cooled cooling air system (described below), lubrication oil systems, compressor bleed air, electrical components, etc.). The heat exchanger 196 uses the air passing through duct 172 as a heat sink and correspondingly increases the temperature of the air downstream of the heat exchanger 196 and exiting the fan exhaust nozzle 178.

As will be appreciated, the engine 100 defines a total sea level static thrust output Fn_{Total}, corrected to standard day conditions, which is generally equal to a maximum total engine thrust. It will be appreciated that “sea level static thrust corrected to standard day conditions” refers to an amount of thrust an engine is capable of producing while at rest relative to the earth and the surrounding air during standard day operating conditions.

The total sea level static thrust output Fn_{Total} may generally be equal to a sum of: a fan stream thrust Fn_{Fan} (i.e., an amount of thrust generated by the fan 152 through the bypass passage 194), the third stream thrust Fn_{3S} (i.e., an amount of thrust generated through the fan duct 172), and a turbomachine thrust Fn_{TM} (i.e., an amount of thrust generated by an airflow through the turbomachine exhaust nozzle 140), each during the static, sea level, standard day conditions. The engine 100 may define a total sea level static thrust output Fn_{Total} greater than or equal to 15,000 pounds. For example, it will be appreciated that the engine 100 may be configured to generate at least 25,000 pounds and less than 80,000 pounds, such as between 25,000 and 50,000 pounds, such as between 35,000 and 45,000 pounds of thrust during a takeoff operating power, corrected to standard day sea level conditions.

As will be appreciated, the engine 100 defines a redline exhaust gas temperature (referred to herein as “EGT”), which is defined above, and for the embodiment of FIG. 1 refers to a maximum permitted takeoff temperature of an airflow after the first stator 208 downstream of the last stage of rotor blades 206 of the HP turbine 132 (at location 215 into the first of the plurality of LP turbine rotor blades 210; see FIG. 2).

Referring now to FIG. 2, a close-up, simplified, schematic view of a portion of the engine 100 of FIG. 1 is provided. The engine 100, as noted above, includes the turbomachine 120 having the LP compressor 126, the HP compressor 128, the combustion section 130, the HP turbine 132, and the LP turbine 134. The LP compressor 126 includes a plurality of stages of LP compressor rotor blades 198 and a plurality of stages of LP compressor stator vanes 200 alternatingly spaced with the plurality of stages of LP compressor rotor blades 198. Similarly, the HP compressor 128 includes a plurality of stages of HP compressor rotor blades 202 and a plurality of stages of HP compressor stator vanes 204 alternatingly spaced with the plurality of stages of HP compressor rotor blades 202. Moreover, within the turbine section, the HP turbine 132 includes at least one stage of HP turbine rotor blades 206 and at least one stage of HP turbine stator vanes 208, and the LP turbine 134 includes a plurality of stages of LP turbine rotor blades 210 and a plurality of stages of LP turbine stator vanes 212 alternatingly spaced with the plurality of stages of LP turbine rotor blades 210. With reference to the HP turbine 132, the HP turbine 132 includes at least a first stage 214 of HP turbine rotor blades 206.

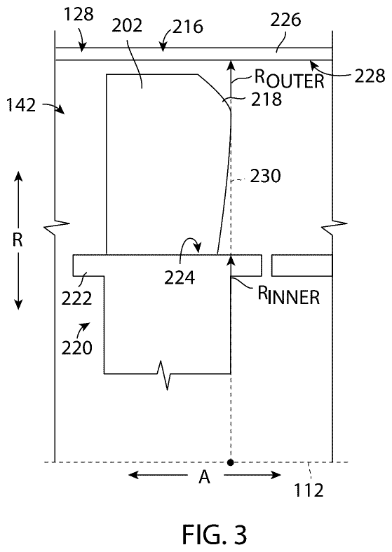

Referring particularly to the HP compressor 128, the plurality of stages of HP compressor rotor blades 202 includes an aftmost stage 216 of HP compressor rotor blades 202. Referring briefly to FIG. 3, a close-up view of an HP compressor rotor blade 202 in the aftmost stage 216 of HP compressor rotor blades 202 is provided. As will be appreciated, the HP compressor rotor blade 202 includes a trailing edge 218 and the aftmost stage 216 of HP compressor rotor blades 202 includes a rotor 220 having a base 222 to which the HP compressor rotor blade 202 is coupled. The base 222 includes a flowpath surface 224 defining in part the working gas flow path 142 through the HP compressor 128. Moreover, the HP compressor 128 includes a shroud or liner 226 located outward of the HP compressor rotor blade 202 along the radial direction R. The shroud or liner 226 also includes a flowpath surface 228 defining in part the working gas flow path 142 through the HP compressor 128.

The engine 100 (FIG. 3) defines a reference plane 230 intersecting with an aft-most point of the trailing edge 218 of the HP compressor rotor blade 202 depicted, the reference plane 230 being orthogonal to the axial direction A. Further, the HP compressor 128 defines a high pressure compressor exit area (A_{HPCExit}) within the reference plane 230. More specifically, the HP compressor 128 defines an inner radius (R_{INNER}) extending along the radial direction R within the reference plane 230 from the longitudinal axis 112 to the flowpath surface 224 of the base 222 of the rotor 220 of the aftmost stage 216 of HP compressor rotor blades 202, as well as an outer radius (R_{OUTER}) extending along the radial direction R within the reference plane 230 from the longitudinal axis 112 to the flowpath surface 228 of the shroud or liner 226. The HP compressor 128 exit area is defined according to Expression (1):

$${A}_{HPCExit} = π ( {R}_{OUTER}^{2} - {R}_{INNER}^{2} ) . \qquad Expression ( 1 )$$

The inventors of the present disclosure have found that for a given total thrust output (Fn_{Total}), a decrease in size of the high pressure compressor exit area (A_{HPCExit}) may generally relate in an increase in a compressor exit temperature (i.e., a temperature of the airflow through the working gas flowpath 142 at the reference plane 230), a turbine inlet temperature (i.e., a temperature of the airflow through the working gas flowpath 142 provided to the first stage 214 of HP turbine rotor blades 206; see FIG. 2), and the redline exhaust gas temperature (EGT). In particular, the inventors of the present disclosure have found that the high pressure compressor exit area (A_{HPCExit}) may generally be used as an indicator of the above temperatures to be achieved by the engine 100 during operation for a given total thrust output (Fn_{Total}) of the engine 100.

Referring back to FIG. 2, the exemplary engine 100 depicted includes one or more technologies to accommodate the relatively small high pressure compressor exit area (A_{HPCExit}) for the total thrust output (Fn_{Total}) of the engine 100. In particular, for the embodiment depicted, the exemplary engine 100 includes a cooled cooling air system 250. The exemplary cooled cooling air system 250 is in fluid communication with the HP compressor 128 and the first stage 214 of HP turbine rotor blades 206. More specifically, for the embodiment depicted, the cooled cooling air system 250 includes a duct assembly 252 and a cooled cooling air (CCA) heat exchanger 254. The duct assembly 252 is in fluid communication with the HP compressor 128 for receiving an airflow from the HP compressor 128 and providing such airflow to the first stage 214 of HP turbine rotor blades 206 during operation of the engine 100. The CCA heat exchanger 254 is in thermal communication with the airflow through the duct assembly 252 for reducing a temperature of the airflow through the duct assembly 252 upstream of the first stage 214 of HP turbine rotor blades 206.

Briefly, as will be explained in more detail below, the engine 100 depicted further includes a thermal transport bus 300, with the CCA heat exchanger 254 of the cooled cooling air system 250 in thermal communication with, or integrated into, the thermal transport bus 300. For the embodiment depicted, the engine 100 further includes the heat exchanger 196 in the fan duct 172 in thermal communication with, or integrated into, the thermal transport bus 300, such that heat from the CCA heat exchanger 254 of the cooled cooling air system 250 may be transferred to the heat exchanger 196 in the fan duct 172 using the thermal transport bus 300.

Referring now to FIG. 4, a close-up, schematic view of the turbomachine 120 of the engine 100 of FIG. 2, including the cooled cooling air system 250, is provided.

As is shown, the compressor section includes a compressor casing 256, and the combustion section 130 of the turbomachine 120 generally includes an outer combustor casing 258, an inner combustor casing 260, and a combustor 262. The combustor 262 generally includes an outer combustion chamber liner 264 and an inner combustion chamber liner 266, together defining at least in part a combustion chamber 268. The combustor 262 further includes a fuel nozzle 270 configured to provide a mixture of fuel and air to the combustion chamber 268 to generate combustion gases.

The engine 100 further includes a fuel delivery system 272 including at least a fuel line 274 in fluid communication with the fuel nozzle 270 for providing fuel to the fuel nozzle 270.

The turbomachine 120 includes a diffuser nozzle 276 located downstream of the aftmost stage 216 of HP compressor rotor blades 202 of the HP compressor 128, within the working gas flowpath 142. In the embodiment depicted, the diffuser nozzle 276 is coupled to, or integrated with the inner combustor casing 260, the outer combustor casing 258, or both. The diffuser nozzle 276 is configured to receive compressed airflow from the HP compressor 128 and straighten such compressed air prior to such compressed air being provided to the combustion section 130. The combustion section 130 defines a diffusion cavity 278 downstream of the diffuser nozzle 276 and upstream of the combustion chamber 268.

As noted above, the exemplary engine 100 further includes the cooled cooling air system 250. The cooled cooling air system 250 includes the duct assembly 252 and the CCA heat exchanger 254. More specifically, the duct assembly 252 includes a first duct 280 in fluid communication with the HP compressor 128 and the CCA heat exchanger 254. The first duct 280 more specifically extends from the HP compressor 128, through the compressor casing 256, to the CCA heat exchanger 254. For the embodiment depicted, the first duct 280 is in fluid communication with the HP compressor 128 at a location in between the last two stages of HP compressor rotor blades 202. In such a manner, the first duct 280 is configured to receive a cooling airflow from the HP compressor 128 and to provide the cooling airflow to the CCA heat exchanger 254.

It will be appreciated, however, that in other embodiments, the first duct 280 may additionally or alternatively be in fluid communication with the HP compressor 128 at any other suitable location, such as at any other location closer to a downstream end of the HP compressor 128 than an upstream end of the HP compressor 128, or alternatively at a location closer to the upstream end of the HP compressor 128 than the downstream end of the HP compressor 128.

The duct assembly 252 further includes a second duct 282 extending from the CCA heat exchanger 254 to the outer combustor casing 258 and a third duct 284 extending from the outer combustor casing 258 inwardly generally along the radial direction R. The CCA heat exchanger 254 may be configured to receive the cooling airflow and to extract heat from the cooling airflow to reduce a temperature of the cooling airflow. The second duct 282 may be configured to receive cooling airflow from the CCA heat exchanger 254 and provide the cooling airflow to the third duct 284. The third duct 284 extends through the diffusion cavity 278 generally along the radial direction R.

Moreover, for the embodiment depicted, the duct assembly 252 further includes a manifold 286 in fluid communication with the third duct 284 and a fourth duct 288. The manifold 286 extends generally along the circumferential direction C of the engine 100, and the fourth duct 288 is more specifically a plurality of fourth ducts 288 extending from the manifold 286 at various locations along the circumferential direction C forward generally along the axial direction A towards the turbine section. In such a manner, the duct assembly 252 of the cooled cooling air system 250 may be configured to provide cooling airflow to the turbine section at a variety of locations along the circumferential direction C.

Notably, referring still to FIG. 4, the combustion section 130 includes an inner stator assembly 290 located at a downstream end of the inner combustion chamber liner 266, and coupled to the inner combustor casing 260. The inner stator assembly 290 includes a nozzle 292. The fourth duct 288, or rather, the plurality of fourth ducts 288, are configured to provide the cooling airflow to the nozzle 292. The nozzle 292 may include a plurality of vanes spaced along the circumferential direction C configured to impart a circumferential swirl to the cooling airflow provided through the plurality of fourth ducts 288 to assist with such airflow being provided to the first stage 214 of HP turbine rotor blades 206.

In particular, for the embodiment depicted, the HP turbine 132 further includes a first stage HP turbine rotor 294, with the plurality of HP turbine rotor blades 206 of the first stage 214 coupled to the first stage HP turbine rotor 294. The first stage HP turbine rotor 294 defines an internal cavity 296 configured to receive the cooling airflow from the nozzle 292 and provide the cooling airflow to the plurality of HP turbine rotor blades 206 of the first stage 214. In such a manner, the cooled cooling air system 250 may provide cooling airflow to the HP turbine rotor blades 206 to reduce a temperature of the plurality HP turbine rotor blades 206 at the first stage 214 during operation of the engine 100.

For example, in certain exemplary aspects, the cooled cooling air system 250 may be configured to provide a temperature reduction of the cooling airflow equal to at least 15% of the EGT and up to 45% of the EGT. Further, in certain exemplary aspects, the cooled cooling air system 250 may be configured to receive between 2.5% and 35% of an airflow through the working gas flowpath 142 at an inlet to the HP compressor 128, such as between 3% and 20%, such as between 4% and 15%.

In addition, as briefly mentioned above, the cooled cooling air system 250 may utilize the thermal transport bus 300 to reject heat from the cooling air extracted from the compressor section of the turbomachine 120. In particular, for the embodiment shown, the CCA heat exchanger 254 is in thermal communication with or integrated into the thermal transport bus 300. Notably, the thermal transport bus 300 further includes a fuel heat exchanger 302 in thermal communication with the fuel line 274. In such a manner, the thermal transport bus 300 may extract heat from the cooling air extracted from the compressor section through the cooled cooling air system 250 and provide such heat to a fuel flow through the fuel line 274 upstream of the fuel nozzle 270.

For the embodiment depicted, the thermal transport bus 300 includes a conduit having a flow of thermal transport fluid therethrough. More specifically, referring now briefly to FIG. 5, a schematic view of a thermal transport bus 300 as may be utilized with the exemplary engine 100 described above with reference to FIGS. 1 through 4 is provided.

The thermal transport bus 300 includes an intermediary heat exchange fluid flowing therethrough and is formed of one or more suitable fluid conduits 304. The heat exchange fluid may be an incompressible fluid having a high temperature operating range. Additionally, or alternatively, the heat exchange fluid may be a single phase fluid, or alternatively, may be a phase change fluid. In certain exemplary embodiments, the heat exchange fluid may be a supercritical fluid, such as a supercritical CO₂.

The exemplary thermal transport bus 300 includes a pump 306 in fluid communication with the heat exchange fluid in the thermal transport bus 300 for generating a flow of the heat exchange fluid in/through the thermal transport bus 300.

Moreover, the exemplary thermal transport bus 300 includes one or more heat source exchangers 308 in thermal communication with the heat exchange fluid in the thermal transport bus 300. Specifically, the thermal transport bus 300 depicted includes a plurality of heat source exchangers 308. The plurality of heat source exchangers 308 are configured to transfer heat from one or more of the accessory systems of an engine within which the thermal transport bus 300 is installed (e.g., engine 100 of FIGS. 1 through 4) to the heat exchange fluid in the thermal transport bus 300. For example, in certain exemplary embodiments, the plurality of heat source exchangers 308 may include one or more of: a CCA heat source exchanger (such as CCA heat exchanger 254 in FIGS. 2 and 4); a main lubrication system heat source exchanger for transferring heat from a main lubrication system; an advanced clearance control (ACC) system heat source exchanger for transferring heat from an ACC system; a generator lubrication system heat source exchanger for transferring heat from the generator lubrication system; an environmental control system (ECS) heat exchanger for transferring heat from an ECS; an electronics cooling system heat exchanger for transferring heat from the electronics cooling system; a vapor compression system heat source exchanger; an air cycle system heat source exchanger; and an auxiliary system(s) heat source exchanger.

For the embodiment depicted, there are three heat source exchangers 308. The heat source exchangers 308 are each arranged in series flow along the thermal transport bus 300. However, in other exemplary embodiments, any other suitable number of heat source exchangers 308 may be included and one or more of the heat source exchangers 308 may be arranged in parallel flow along the thermal transport bus 300 (in addition to, or in the alternative to the serial flow arrangement depicted). For example, in other embodiments there may be a single heat source exchanger 308 in thermal communication with the heat exchange fluid in the thermal transport bus 300, or alternatively, there may be at least two heat source exchangers 308, at least four heat source exchangers 308, at least five heat source exchangers 308, or at least six heat source exchangers 308, and up to twenty heat source exchangers 308 in thermal communication with heat exchange fluid in the thermal transport bus 300.

Additionally, the exemplary thermal transport bus 300 of FIG. 5 further includes one or more heat sink exchangers 310 permanently or selectively in thermal communication with the heat exchange fluid in the thermal transport bus 300. The one or more heat sink exchangers 310 are located downstream of the plurality of heat source exchangers 308 and are configured for transferring heat from the heat exchange fluid in the thermal transport bus 300, e.g., to atmosphere, to fuel, to a fan stream, etc. For example, in certain embodiments the one or more heat sink exchangers 310 may include at least one of a RAM heat sink exchanger, a fuel heat sink exchanger, a fan stream heat sink exchanger, a bleed air heat sink exchanger, an engine intercooler heat sink exchanger, a bypass passage heat sink exchanger, or a cold air output heat sink exchanger of an air cycle system. The fuel heat sink exchanger is a “fluid to heat exchange fluid” heat exchanger wherein heat from the heat exchange fluid is transferred to a stream of liquid fuel (see, e.g., fuel heat exchanger 302 of the engine 100 of FIG. 4). Moreover, the fan stream heat sink exchanger is generally an “air to heat exchange fluid” heat exchanger which transfers heat from the heat exchange fluid to an airflow through the fan stream (see, e.g., heat exchanger 196 of FIGS. 1 and 2). Further, the bleed air heat sink exchanger is generally an “air to heat exchange fluid” heat exchanger which flows, e.g., bleed air from the LP compressor 126 over the heat exchange fluid to remove heat from the heat exchange fluid.

For the embodiment of FIG. 5, the one or more heat sink exchangers 310 of the thermal transport bus 300 depicted includes a plurality of individual heat sink exchangers 310. More particularly, for the embodiment of FIG. 5, the one or more heat sink exchangers 310 include three heat sink exchangers 310 arranged in series. The three heat sink exchangers 310 are configured as a bypass passage heat sink exchanger, a fuel heat sink exchanger, and a fan stream heat sink exchanger. However, in other exemplary embodiments, the one or more heat sink exchangers 310 may include any other suitable number and/or type of heat sink exchangers 310. For example, in other exemplary embodiments, a single heat sink exchanger 310 may be provided, at least two heat sink exchangers 310 may be provided, at least four heat sink exchangers 310 may be provided, at least five heat sink exchangers 310 may be provided, or up to twenty heat sink exchangers 310 may be provided. Additionally, in still other exemplary embodiments, two or more of the one or more heat sink exchangers 310 may alternatively be arranged in parallel flow with one another.

Referring still to the exemplary embodiment depicted in FIG. 5, one or more of the plurality of heat sink exchangers 310 and one or more of the plurality of heat source exchangers 308 are selectively in thermal communication with the heat exchange fluid in the thermal transport bus 300. More particularly, the thermal transport bus 300 depicted includes a plurality of bypass lines 312 for selectively bypassing each heat source exchanger 308 and each heat sink exchanger 310 in the plurality of heat sink exchangers 310. Each bypass line 312 extends between an upstream juncture 314 and a downstream juncture 316—the upstream juncture 314 located just upstream of a respective heat source exchanger 308 or heat sink exchanger 310, and the downstream juncture 316 located just downstream of the respective heat source exchanger 308 or heat sink exchanger 310.

Additionally, each bypass line 312 meets at the respective upstream juncture 314 with the thermal transport bus 300 via a three-way valve 318. The three-way valves 318 each include an inlet fluidly connected with the thermal transport bus 300, a first outlet fluidly connected with the thermal transport bus 300, and a second outlet fluidly connected with the bypass line 312. The three-way valves 318 may each be a variable throughput three-way valve, such that the three-way valves 318 may vary a throughput from the inlet to the first and/or second outlets. For example, the three-way valves 318 may be configured for providing anywhere between zero percent (0%) and one hundred percent (100%) of the heat exchange fluid from the inlet to the first outlet, and similarly, the three-way valves 318 may be configured for providing anywhere between zero percent (0%) and one hundred percent (100%) of the heat exchange fluid from the inlet to the second outlet.

Notably, the three-way valves 318 may be in operable communication with a controller of an engine including the thermal transport bus 300 (e.g., engine 100 of FIGS. 1 through 4).

Further, each bypass line 312 also meets at the respective downstream juncture 316 with the thermal transport bus 300. Between each heat source exchanger 308 or heat sink exchanger 310 and downstream juncture 316, the thermal transport bus 300 includes a check valve 320 for ensuring a proper flow direction of the heat exchange fluid. More particularly, the check valve 320 prevents a flow of heat exchange fluid from the downstream juncture 316 towards the respective heat source exchanger 308 or heat sink exchanger 310.

As alluded to earlier, the inventors discovered, unexpectedly during the course of gas turbine engine design—i.e., designing gas turbine engines having a variety of different high pressure compressor exit areas, total thrust outputs, redline exhaust gas temperatures, and supporting technology characteristics and evaluating an overall engine performance and other qualitative turbofan engine characteristics—a significant relationship between a total sea level static thrust output, a compressor exit area, and a redline exhaust gas temperature that enables increased engine core operating temperatures and overall engine propulsive efficiency. The relationship can be thought of as an indicator of the ability of a turbofan engine to have a reduced weight or volume as represented by a high pressure compressor exit area, while maintaining or even improving upon an overall thrust output, and without overly detrimentally affecting overall engine performance and other qualitative turbofan engine characteristics. The relationship applies to an engine that incorporates a cooled cooling air system, builds portions of the core using material capable of operating at higher temperatures, or a combination of the two. Significantly, the relationship ties the core size (as represented by the exit area of the higher pressure compressor) to the desired thrust and exhaust gas temperature associated with the desired propulsive efficiency and practical limitations of the engine design, as described below.

Referring to the case of an engine that utilizes cooled cooling air for operating at higher temperatures, the inventors discovered, unexpectedly, that the costs associated with achieving a higher compression, enabled by reducing gas temperatures used to cool core components to accommodate higher core gas temperatures, may indeed produce a net benefit, contrary to expectations in the art. Referring to the case of utilizing more temperature-resistant material, such as a Carbon Matrix Composite (CMC), it was found that certain aspects of the engine size, weight and operating characteristics can be positively affected while taking into account the complexities and/or drawbacks associated with such material. In either case, the relationship now described can apply to identify the interrelated operating conditions and core size—i.e., total sea level static thrust, redline exhaust gas temperature, and compressor exit area, respectively.

The inventors of the present disclosure discovered bounding the relationship between a product of total thrust output and redline exhaust gas temperature at a takeoff power level and the high pressure compressor exit area squared (corrected specific thrust) can result in a higher power density core. This bounded relationship, as described herein, takes into due account the amount of overall complexity and cost, and/or a low amount of reliability associated with implementing the technologies required to achieve the operating temperatures and exhaust gas temperature associated with the desired thrust levels. The amount of overall complexity and cost may be prohibitively high for gas turbine engines outside the bounds of the relationship as described herein, and/or the reliability may prohibitively low outside the bounds of the relationship as described herein. The relationship discovered, infra, can therefore identify an improved engine configuration suited for a particular mission requirement, one that takes into account efficiency, weight, cost, complexity, reliability, and other factors influencing the optimal choice for an engine configuration.

In addition to yielding an improved gas turbine engine, as explained in detail above, utilizing this relationship, the inventors found that the number of suitable or feasible gas turbine engine designs capable of meeting the above design requirements could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationship providing for the improved gas turbine engine, discovered by the inventors, is expressed as:

$$CST = {Fn}_{Total} \times EGT / ( {A}_{HPCExit}^{2} \times 1000 ) , \qquad Expression ( 2 )$$

where CST is corrected specific thrust; Fn_{Total} is a total sea level static thrust output of the gas turbine engine in pounds; EGT is redline exhaust gas temperature in degrees Celsius; and A_{HPCExit} is a high pressure compressor exit area in square inches.

CST values of an engine defined by Expression (2) in accordance with various embodiments of the present disclosure are from 42 to 90, such as from 45 to 80, such as from 50 to 80. The units of the CST values may be pounds-degrees Celsius over square inches.

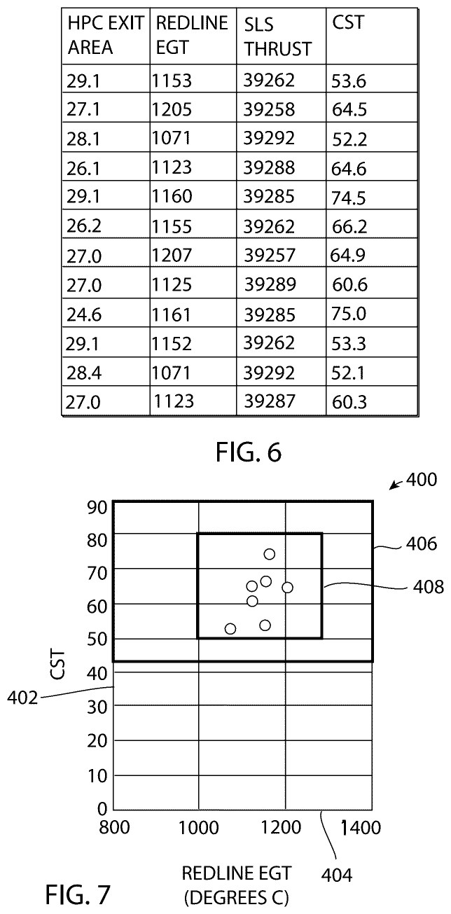

Referring now to FIGS. 6 and 7, various exemplary gas turbine engines are illustrated in accordance with one or more exemplary embodiments of the present disclosure. In particular, FIG. 6 provides a table including numerical values corresponding to several of the plotted gas turbine engines in FIG. 7. FIG. 7 is a plot 400 of gas turbine engines in accordance with one or more exemplary embodiments of the present disclosure, showing the CST on a Y-axis 402 and the EGT on an X-axis 404.

As shown, the plot 400 in FIG. 7 depicts a first range 406, with the CST values between 42 and 90 and EGT values from 800 degrees Celsius to 1400 degrees Celsius. FIG. 7 additionally depicts a second range 408, with the CST values between 50 and 80 and EGT values from 1000 degrees Celsius to 1300 degrees Celsius. It will be appreciated that in other embodiments, the EGT value may be greater than 1100 degree Celsius and less than 1250 degrees Celsius, such as greater than 1150 degree Celsius and less than 1250 degrees Celsius, such as greater than 1000 degree Celsius and less than 1300 degrees Celsius.

It will be appreciated that although the discussion above is generally related to an open rotor engine having a particular cooled cooling air system 250 (FIG. 2), in various embodiments of the present disclosure, the relationship outlined above with respect to Expression (2) may be applied to any other suitable engine architecture, including any other suitable technology(ies) to allow the gas turbine engine to accommodate higher temperatures to allow for a reduction in the high pressure compressor exit area, while maintaining or even increasing the maximum turbofan engine thrust output without, e.g., prematurely wearing various components within the turbomachine exposed the working gas flowpath.

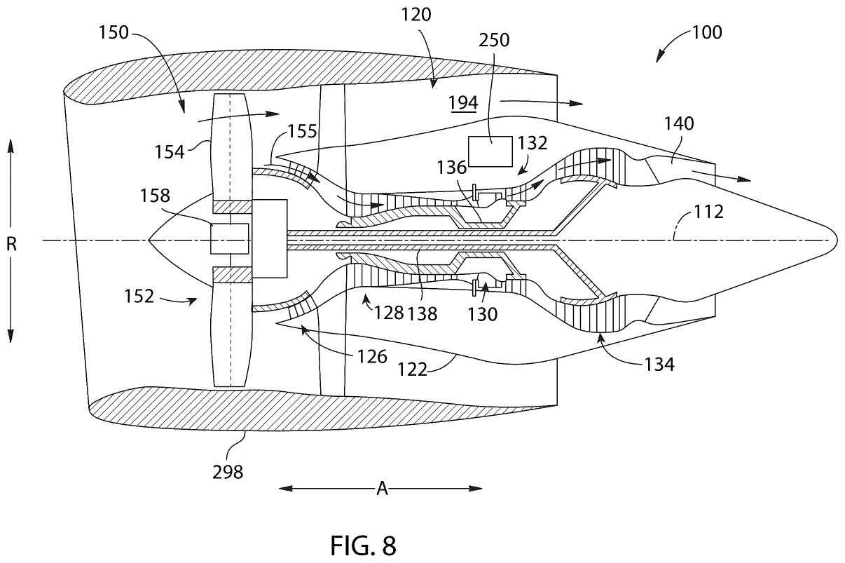

For example, reference will now be made to FIG. 8. FIG. 8 provides a schematic view of an engine 100 in accordance with another exemplary embodiment of the present disclosure. The exemplary embodiment of FIG. 8 may be configured in substantially the same manner as the exemplary engine 100 described above with respect to FIGS. 1 through 4, and the same or similar reference numerals may refer to the same or similar parts. However, as will be appreciated, for the embodiment shown, the engine 100 further includes an outer housing or nacelle 298 circumferentially surrounding at least in part a fan section 150 and a turbomachine 120. The nacelle 298 defines a bypass passage 194 between the nacelle 298 and the turbomachine 120.

Briefly, it will be appreciated that the exemplary engine 100 of FIG. 8 is configured as a two-stream engine, i.e., an engine without a third stream (e.g., fan stream 172 in the exemplary engine 100 of FIG. 2). With such a configuration, a total sea level static thrust output Fn_{Total} of the engine 100 may generally be equal to a sum of: a fan stream thrust Fn_{Fan} (i.e., an amount of thrust generated by a fan 152 through a bypass passage 194) and a turbomachine thrust Fn_{TM} (i.e., an amount of thrust generated by an airflow through a turbomachine exhaust nozzle 140), each during the static, sea level, standard day conditions.

Further, for the exemplary embodiment of FIG. 8, the engine 100 additionally includes a cooled cooling air system 250 configured to provide a turbine section with cooled cooling air during operation of the engine 100, to allow the engine 100 to accommodate higher temperatures to allow for a reduction in a high pressure compressor exit area, while maintaining or even increasing a maximum turbofan engine thrust output.

It will be appreciated that in other exemplary embodiments of the present disclosure, the cooled cooling air system 250 of the engine 100 may be configured in any other suitable manner. For example, the exemplary cooled cooling air system 250 described above with reference to FIGS. 2 and 3 is generally configured as a thermal bus cooled cooling air system. However, in other embodiments, the cooled cooling air system 250 may instead be a dedicated heat exchanger cooled cooling air system (i.e., a cooled cooling air system including a heat exchanger that transfers heat directly to a cooling medium). Additionally, in other embodiments, the cooled cooling air system 250 may be a bypass heat exchanger cooled cooling air system having a heat sink heat exchanger thermally coupled to an airflow through a bypass passage (see, e.g., FIG. 9, discussed below). Additionally, or alternatively, in other embodiments, the cooled cooling air system 250 may be one of an air-to-air cooled cooling air system (a cooled cooling air system having a heat sink heat exchanger configured to transfer heat to an airflow; see, e.g., FIG. 9, discussed below); an oil-to-air cooled cooling air system (a cooled cooling air system having a heat sink heat exchanger configured to transfer heat to an oil flow); or a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc.; see, e.g., FIG. 4).

More particularly, referring generally to FIGS. 9 through 11, in other exemplary embodiments, the cooled cooling air system 250 of the engine 100 may be configured in any other suitable manner. The exemplary engines 100 depicted in FIGS. 9 through 11 may be configured in a similar manner as exemplary engine 100 described above with reference to FIGS. 1 through 4, and the same or similar numbers may refer to the same or similar parts.

For example, each of the exemplary engines 100 depicted in FIGS. 9 through 11 generally includes a turbomachine 120 having an LP compressor 126, an HP compressor 128, a combustion section 130, an HP turbine 132, and an LP turbine 134 collectively defining at least in part a working gas flowpath 142 and arranged in serial flow order. The exemplary turbomachine 120 depicted additionally includes a core cowl 122, and the engine 100 includes a fan cowl 170. The engine 100 includes or defines a fan duct 172 positioned partially between the core cowl 122 and the fan cowl 170. Moreover, a bypass passage 194 is defined at least in part by the core cowl 122, the fan cowl 170, or both and extends over the turbomachine 120.

Moreover, the exemplary engines 100 depicted in FIGS. 9 to 11 additionally include a cooled cooling air system 250. The cooled cooling air system 250 generally includes a duct assembly 252 and a CCA heat exchanger 254.

However, referring in particular to FIG. 9, it will be appreciated that for the exemplary embodiment depicted, the CCA heat exchanger 254 is positioned in thermal communication with the bypass passage 194, and more specifically, it is exposed to an airflow through or over the bypass passage 194. For the embodiment of FIG. 9, the CCA heat exchanger 254 is positioned on the core cowl 122. In such a manner, the CCA heat exchanger 254 may be an air-to-air CCA heat exchanger configured to exchange heat between an airflow extracted from the HP compressor 128 and the airflow through the bypass passage 194.

As is depicted in phantom, the cooled cooling air system 250 may additionally or alternatively be positioned at any other suitable location along the bypass passage 194, such as on the fan cowl 170. Further, although depicted in FIG. 9 as being positioned on the core cowl 122, in other embodiments, the CCA heat exchanger 254 may be embedded into the core cowl 122, and airflow through the bypass passage 194 may be redirected from the bypass passage 194 to the CCA heat exchanger 254.

As will be appreciated, a size of the CCA heat exchanger 254 may affect the amount of drag generated by the CCA heat exchanger 254 being positioned within or exposed to the bypass passage 194. Accordingly, sizing the cooled cooling air system 250 in accordance with the present disclosure may allow for a desired reduction in a HP compressor 128 exit area, while maintaining or even increasing a total thrust output for the engine 100, without creating an excess amount of drag on the engine 100 in the process.

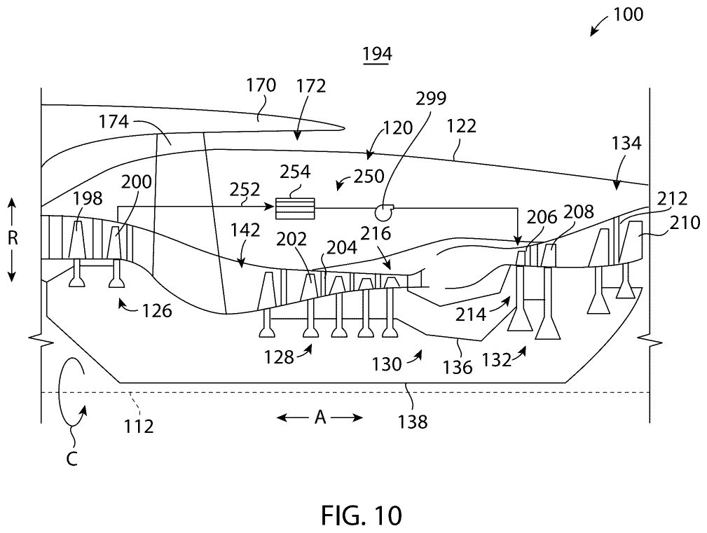

Referring now particular to FIG. 10, it will be appreciated that for the exemplary embodiment depicted, the cooled cooling air system 250 is configured to receive the cooling airflow from an air source upstream of a downstream half of the HP compressor 128. In particular, for the exemplary embodiment of FIG. 10, the exemplary cooled cooling air system 250 is configured to receive the cooling airflow from a location upstream of the HP compressor 128, and more specifically, still, from the LP compressor 126. In order to allow for a relatively low pressure cooling airflow to be provided to a first stage 214 of HP turbine rotor blades 206 of the HP turbine 132, the cooled cooling air system 250 further includes a pump 299 in airflow communication with the duct assembly 252 to increase a pressure of the cooling airflow through the duct assembly 252. For the exemplary aspect depicted, the pump 299 is positioned downstream of the CCA heat exchanger 254. In such a manner, the pump 299 may be configured to increase the pressure of the cooling airflow through the duct assembly 252 after the cooling airflow has been reduced in temperature by the CCA heat exchanger 254. Such may allow for a reduction in wear on the pump 299.

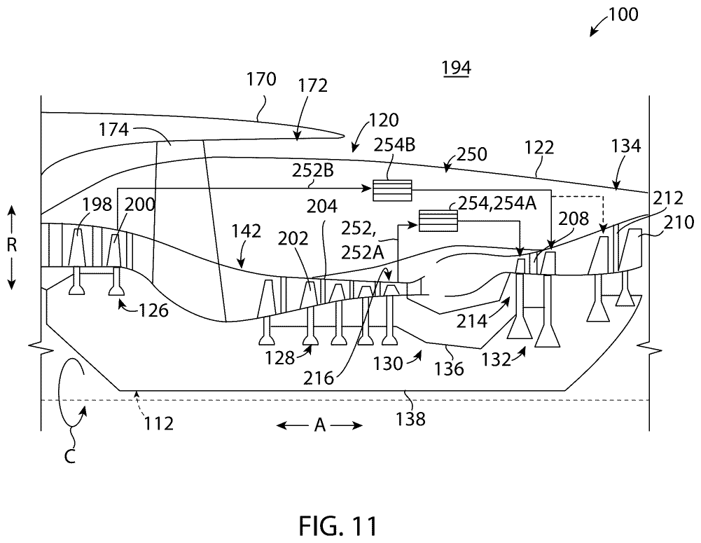

Referring now particularly to FIG. 11, it will be appreciated that the cooled cooling air system 250 includes a high-pressure portion and a low-pressure portion operable in parallel. In particular, the duct assembly 252 includes a high-pressure duct assembly 252A and a low-pressure duct assembly 252B, and the CCA heat exchanger 254 includes a high-pressure CCA heat exchanger 254A and a low-pressure CCA heat exchanger 254B.

The high-pressure duct assembly 252A is in fluid communication with the HP compressor 128 at a downstream half of the high-pressure compressor and is further in fluid communication with a first stage 214 of HP turbine rotor blades 206. The high-pressure duct assembly 252A may be configured to receive a high-pressure cooling airflow from the HP compressor 128 through the high-pressure duct assembly 252A and provide such high-pressure cooling airflow to the first stage 214 of HP turbine rotor blades 206. The high-pressure CCA heat exchanger 254A may be configured to reduce a temperature of the high-pressure cooling airflow through the high-pressure duct assembly 252A at a location upstream of the first stage 214 of HP turbine rotor blades 206.

The low-pressure duct assembly 252B is in fluid communication with a location upstream of the downstream half of the high pressure compressor 128 and is further in fluid communication with the HP turbine 132 and a location downstream of the first stage 214 of HP turbine rotor blades 206. In particular, for the embodiment depicted, the low-pressure duct assembly 252B is in fluid communication with the LP compressor 126 and a second stage (not labeled) of HP turbine rotor blades 206. The low-pressure duct assembly 252B may be configured to receive a low-pressure cooling airflow from the LP compressor 126 through the low-pressure duct assembly 252B and provide such low-pressure cooling airflow to the second stage of HP turbine rotor blades 206. The low-pressure CCA heat exchanger 254B may be configured to reduce a temperature of the low-pressure cooling airflow through the low-pressure duct assembly 252B upstream of the second stage of HP turbine rotor blades 206.

Inclusion of the exemplary cooled cooling air system 250 of FIG. 11 may reduce an amount of resources utilized by the cooled cooling air system 250 to provide a desired amount of cooling for the turbomachine 120.

Further, for the exemplary embodiment of FIG. 11, it will be appreciated that the cooled cooling air system 250 may further be configured to provide cooling to one or more stages of LP turbine rotor blades 210, and in particular to a first stage (i.e., upstream-most stage) of LP turbine rotor blades 210. Such may further allow for, e.g., the higher operating temperatures described herein.

Reference will now be made briefly to FIG. 12. FIG. 12 provides a schematic view of an engine 500 in accordance with another exemplary embodiment of the present disclosure. The exemplary embodiment of FIG. 12 may be configured in substantially the same manner as the exemplary engine 100 described above with respect to FIGS. 1 through 4, and the same or similar reference numerals may refer to the same or similar parts. However, as will be appreciated, for the embodiment shown, the engine 500 is configured as a three-spool engine, instead of a two-spool engine.

For example, the exemplary engine 500 includes a fan section 502 and a turbomachine 504. The fan section includes a fan 506. The turbomachine includes a first compressor 508, a second compressor 510, a combustion section 512, a first turbine 514, a second turbine 516, and a third turbine 518. The first compressor 508 may be a high pressure compressor, the second compressor 510 may be a medium pressure compressor (or intermediate pressure compressor), the first turbine 514 may be a high pressure turbine, the second turbine 516 may be a medium pressure turbine (or intermediate pressure turbine), and the third turbine 518 may be a low pressure turbine. Further, the engine 500 includes a first shaft 520 extending between, and rotatable with both of, the first compressor 508 and first turbine 514; a second shaft 522 extending between, and rotatable with both of, the second compressor 510 and second turbine 516; and a third shaft 524 extending between, and rotatable with both of, the third turbine 518 and fan 506. In such a manner, it will be appreciated that the engine 500 may be referred to as a three-spool engine.

For the embodiment of FIG. 12, the term redline EGT refers to a maximum temperature of an airflow after the first stator downstream of the last stage of rotor blades of the intermediate speed turbine, e.g., at location 526 in FIG. 12 (assuming the intermediate speed turbine 516 includes a stage of stator vanes downstream of the last stage of rotor blades).

It will further be appreciated that the exemplary cooled cooling air systems 250 described hereinabove are provided by way of example only. In other exemplary embodiments, aspects of one or more of the exemplary cooled cooling air systems 250 depicted may be combined to generate still other exemplary embodiments. For example, in still other exemplary embodiments, the exemplary cooled cooling air system 250 of FIGS. 2 through 4 may not be utilized with a thermal transport bus (e.g., thermal transport bus 300), and instead may directly utilize a CCA heat exchanger 254 positioned within the fan duct 172. Similarly, in other example embodiment, the exemplary cooled cooling air systems 250 of FIGS. 9 through 11 may be utilized with a thermal transport bus (e.g., thermal transport bus 300 of FIG. 2, 4 or 5) to reject heat for the CCA heat exchanger 254. Additionally, although the exemplary cooled cooling air systems 250 depicted schematically in FIGS. 9 through 11 depict the duct assembly 252 as positioned outward of the working gas flow path 142 along the radial direction R, in other exemplary embodiments, the duct assemblies 252 may extend at least partially inward of the working gas flow path 142 along the radial direction R (see, e.g., FIG. 4). In still other exemplary embodiments, the cooled cooling air system 250 may include duct assemblies 252 positioned outward of the working gas flow path 142 along the radial direction R and inward of the working gas flow path 142 along the radial direction R (e.g., in FIG. 11, the high-pressure duct assembly 252A may be positioned inwardly of the working gas flow path 142 along the radial direction R and the low-pressure duct assembly 252B may be positioned outwardly of the working gas flow path 142 along the radial direction R).

Moreover, it will be appreciated that in still other exemplary aspects, the gas turbine engine may include additional or alternative technologies to allow the gas turbine engine to accommodate higher temperatures while maintaining or even increasing the maximum turbofan engine thrust output, as may be indicated by a reduction in the high pressure compressor exit area, without, e.g., prematurely wearing on various components within the turbomachine exposed to the working gas flowpath.

For example, in additional or alternative embodiments, a gas turbine engine may incorporate advanced materials capable of withstanding the relatively high temperatures at downstream stages of a high pressure compressor exit (e.g., at a last stage of high pressure compressor rotor blades), and downstream of the high pressure compressor (e.g., a first stage of an HP turbine, downstream stages of the HP turbine, an LP turbine, an exhaust section, etc.).

In particular, in at least certain exemplary embodiments, a gas turbine engine of the present disclosure may include an airfoil (e.g., rotor blade or stator vane) in one or more of the HP compressor, the first stage of the HP turbine, downstream stages of the HP turbine, the LP turbine, the exhaust section, or a combination thereof formed of a ceramic-matrix-composite or “CMC.” As used herein, the term CMC refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al2O3 2SiO2), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

One or more of these components formed of a CMC material may include an environmental-barrier-coating or “EBC.” The term EBC refers to a coating system including one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., including barium-strontium-aluminum silicate (BSAS), such as having a range of BaO, SrO, Al₂O₃, and/or SiO₂ compositions), hermetic layers (e.g., a rare earth disilicate), and/or outer coatings (e.g., comprising a rare earth monosilicate, such as slurry or APS-deposited yttrium monosilicate (YMS)). One or more layers may be doped as desired, and the EBC may also be coated with an abradable coating.

In such a manner, it will be appreciated that the EBCs may generally be suitable for application to “components” found in the relatively high temperature environments noted above. Examples of such components can include, for example, combustor components, turbine blades, shrouds, nozzles, heat shields, and vanes.

Additionally, or alternatively still, in other exemplary embodiments, a gas turbine engine of the present disclosure may include an airfoil (e.g., rotor blade or stator vane) in one or more of an HP compressor, a first stage of an HP turbine, downstream stages of the HP turbine, an LP turbine, an exhaust section, or a combination thereof formed in part, in whole, or in some combination of materials including but not limited to titanium, nickel, and/or cobalt based superalloys (e.g., those available under the name Inconel® available from Special Metals Corporation). One or more of these materials are examples of materials suitable for use in an additive manufacturing processes.

Further, it will be appreciated that in at least certain exemplary embodiments of the present disclosure, a method of operating a gas turbine engine is provided. The method may be utilized with one or more of the exemplary gas turbine engines discussed herein, such as in FIGS. 1 through 4 and 8 through 11. The method includes operating the gas turbine engine at a takeoff power level, the gas turbine engine having a turbomachine with a high pressure compressor defining a high pressure compressor exit area (A_{HPCExit}) in square inches. The gas turbine engine further defines a redline exhaust gas temperature (EGT) in degrees Celsius, a total sea level static thrust output (Fn_{Total}) in pounds, and a corrected specific thrust. The corrected specific thrust is greater than or equal to 42 and less than or equal to 90, the corrected specific thrust determined as follows: Fn_{Total}×EGT/(A_{HPCExit}²×1000).

In certain exemplary aspects, operating the gas turbine engine at the takeoff power level further includes reducing a temperature of a cooling airflow provided to a high pressure turbine of the gas turbine engine with a cooled cooling air system. For example, in certain exemplary aspects, reducing the temperature of the cooling airflow provided to the high pressure turbine of the gas turbine engine with the cooled cooling air system comprises providing a temperature reduction of the cooling airflow equal to at least 15% of the EGT and up to 45% of the EGT.

As will be appreciated from the description herein, various embodiments of a gas turbine engine are provided. Certain of these embodiments may be an unducted, single rotor gas turbine engine (see FIG. 1), a turboprop engine, or a ducted turbofan engine (see FIG. 8). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects may be combined with one or more of the exemplary gas turbine engine(s) discussed above with respect to the FIGS.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.1 to 14.0, within a range of 4.5 to 14.0, or within a range of 6.0 to 14.0. In certain embodiments, the gear ratio is within a range of 3.2 to 12 or within a range of 4.5 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 4 to 15 stages, a high-pressure turbine may include 1 to 2 stages, and/or a low pressure turbine (LPT) may include 1 to 7 stages. In particular, the LPT may have 4 stages, or between 4 and 6 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least 2. In another embodiment, L/Dcore is at least 2.5. In some embodiments, the L/Dcore is less than 5, less than 4, and less than 3. In various embodiments, it should be appreciated that the L/Dcore is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above in some instances as an unshrouded or open rotor engine, it should be appreciated that aspects of the disclosure provided herein may be applied to shrouded or ducted engines (see, e.g., FIGS. 8-11 and FIGS. 13-17), partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (Dcore) of the engine, L/Dcore of the engine, desired cruise altitude, and/or desired operating cruise speed, or combinations thereof.

In an extension of the concepts disclosed hereinabove, also provided are engines that exhibit a sought-after trade-off between aerodynamic performance and durability of a turbine nozzle. In some embodiments, the high pressure compressor exit area A_{HPCExit} can be selected according to the relationship defined above with respect to CST, FN_{Total}, and EGT, which can dictate, at least in part, the inner radius R_{INNER} of the HP compressor 128. That inner radius R_{INNER} can then be utilized for selecting the turbine lead hub radius Rt to obtain a desired core radius ratio CRR between the HP compressor and the HP turbine. Such a configuration can provide an engine with the sought-after trade-off between aerodynamic performance and durability of the turbine nozzle, and the engine can also have a reduced weight or volume, as represented by the high pressure compressor exit area, while maintaining or even improving upon an overall thrust output, and without overly detrimentally affecting overall engine performance and other qualitative engine characteristics.

In some examples, some of the pressurized air from the compressor section of a gas turbine engine can be bled off from one of the early compressor stages, bypass the combustion section, and be internally routed to portions of the turbine section, such as via a cooled cooling air system (see, e.g., cooled cooling air system 250 of FIGS. 8-11). The bleed air may be routed for local cooling, such as film cooling, or injected into the combustion gases just upstream of the turbine section to cool the combustion air by dilution. In some examples, this compressor cooling air can be referred to as bypass cooling air since it bypasses the combustion section and is not used for combustion.

The first stage of the turbine section is immediately downstream of the combustion section and includes a first stage turbine nozzle upstream of first stage turbine rotor blades. The first stage turbine nozzle, being the closest or most proximal turbine stage to the combustion section, encounters the harshest thermal environment. Of any part of the turbine section, the first stage turbine nozzle sees the harshest environment from the post-combustion working air in terms of both absolute temperature and enthalpy flux. For example, the absolute temperature of the post-combustion air can be above the melting point of the material forming the first stage turbine nozzle. The exposure of the first stage turbine nozzle to this harsh environment reduces its durability, especially as compared to other components of the turbine section, including the other stages and the first stage turbine rotor blades, which benefit from a dilution of the combustion gas by cooling air from the compressor that is internally supplied to the first stage turbine nozzle.

To address the consequences of the harsh thermal environment on the first stage turbine nozzle, compressor cooling air is internally routed (e.g., via a cooled cooling air system 250 of FIGS. 8-11) to the first stage turbine nozzle for cooling, which can include film cooling of the exterior of the first stage turbine nozzle. The compressor cooling air that is used for film cooling is emitted into the working airflow and dilutes the combustion gases exiting the combustor. The addition of the internal compressor cooling air increases the thermal protection and improves the durability of the first stage turbine nozzle, and the dilution of the gas temperature is a benefit to the downstream turbine components. The compressor cooling air used for film cooling is added to the working air as it passes through the first stage turbine nozzle and reduces the enthalpy flux to the turbine downstream of the first stage turbine nozzle.

The first stage turbine nozzle is not used to extract work from the post-combustion working airflow, and is, from a thermodynamic standpoint, treated as part of the combustion section. The temperature of the working airflow at the exit of the first stage turbine nozzle sets the enthalpy available for work extraction by the turbine section. The exit of the first stage turbine nozzle is referred to as the firing plane. The working air temperature at the firing plane is referred to as the firing temperature, which is used to rate the turbine for its potential work extraction. Compressor cooling air introduced upstream of the firing plane is referred to as non-chargeable cooling air. Compressor cooling air introduced downstream of the firing plane is referred to as chargeable cooling air.

In some engines, compressor cooling air is also used in the combustor to control aspects of the combustion process, which can include dilution of the temperature of the gases leaving the combustor. When designing a gas turbine engine, the firing plane temperature is assumed fixed to size the engine. The firing plane temperature sets the available enthalpy for work by the turbine section. The available enthalpy sets the power available for compression and thrust, or shaft power for shaft power turboprop engines. Under a fixed firing plane temperature, multiple upstream factors (e.g., compressor outlet temperature, flame temperature, use of compressor cooling air, configuration of the first stage turbine nozzle, etc.) can impact the firing plane temperature. As one of these factors is altered, it provides for an offsetting or altering of one or more of the other factors to maintain the same firing plane temperature. For example, the first stage turbine nozzle can be modified, which enables changes to other upstream factors, such as an amount of non-chargeable compressor cooling air, to reduce the harshness of the thermal environment of the first stage turbine nozzle, which increases the durability of the first stage turbine nozzle.

The durability of the first stage turbine nozzle competes with the desire for aerodynamic performance. One way to think about the competing desires is via how compressor air is being used as it passes through the engine. The more compressor cooling air diverted to cool the first stage nozzle, the less compressed air combusted, which means less kinetic energy available in the gases exiting the combustor for mechanical work. Thus, reducing first stage turbine nozzle compressor cooling air increases system performance (since less air has to be compressed by the compressor), but at the expense of durability. By reducing the amount of first stage turbine nozzle cooling air, the combustor exit temperature decreases (for a fixed firing plane temperature) since the amount of dilution (e.g., by the film cooling air) inside the nozzle flow path is reduced.

The design dilemma between the choices of a first stage turbine nozzle with enhanced durability vs. aerodynamic performance of the engine is not easily resolved. The inventors have conceived, designed and tested several different types of gas turbine engines having different thrust ratings and/or mission requirements. During this period, several different aspects of an engine architecture must be considered whenever a turbine nozzle is being re-designed. Among those parameters are first stage turbine nozzle solidity, blade length, overall pressure ratio (OPR), combustor type, and compressor bleed. Each can have positive and/or negative impacts on others in terms of design feasibility and penalties that must be accepted in favor of a design change.

Fuel efficiency and aerodynamic performance of the gas turbine engine is at least in part a function of the OPR of the compression section. The OPR is indicative of an amount of compression of the working airflow accomplished by the compressor section and can be expressed as the ratio of a stagnation pressure measured at the rear or downstream end of the compressor section as compared to the stagnation pressure measured at the inlet or upstream end of the fan section. All other things being equal, the greater the OPR, the greater the fuel efficiency of the gas turbine engine. While increasing the OPR may seem like an easy solution, it is not without its tradeoffs.

For example, to increase the OPR of a turbine engine, the number of stages in a high-pressure compressor (HPC) is increased. The more stages, the higher the OPR. A stage is defined by a fixed row of airfoils (nozzle) that follows or precedes a rotating set of airfoils. The more stages the greater the OPR. As the gas is compressed further by increasing stages, its temperature also increases, which can impose material-based limits on an achievable compression ratio. The HPC is coupled to a high-pressure turbine (HPT) by a high-pressure shaft or spool.

Increased use of compressor cooling air further reduces fuel efficiency because, as more compressor air bypasses the combustor, there is less compressor air available for combustion, the resulting increase in the fuel-to-air ratio (FAR) raises the combustion flame temperature. Assuming the combustor firing plane temperature is held constant, (i.e., based on a combination of the flame temperature and the compressor cooling air introduced upstream of the firing plane, equals the same firing plane temperature), the first stage turbine nozzle durability decreases with an increase in the flame temperature.

The flame temperature also has an impact on exhaust emissions of the aircraft which can impact local air quality. One of the more difficult exhaust emissions to control are oxides of nitrogen, or nitric oxide (NO), commonly referred to as NOx, and consist of NO and NO₂. NOx emissions for aircraft are highly regulated. All commercially available engines are subject to formal, governmental testing, using standard methodologies, which includes tracking the NOx generation of the engine at a given engine thrust. For example, in the U.S., the Fuel venting and Exhaust Emission Requirements for Turbine Powered Airplanes (FAR part 34) guides compliance with the Environmental Protection Agency (EPA) aircraft exhaust emission standards. Internationally, the International Civil Aviation Organization (ICAO) sets emissions standards for jet engines and evaluates the environmental performance of aircraft engines. The ICAO emissions standards address, among other things, gaseous exhaust emissions from jet engines including NOx. The ICAO engine certification process is based on the Landing and Take-off (LTO) cycle. This LTO cycle representing pollutant emissions consists of four operating modes, which involve a thrust setting and a time-in mode. For each thrust setting and corresponding fuel flow, the pollutant emissions are measured in accordance with relevant standards.

A NOx generation value is typically determined for all commercially available engines and conventionally referred to as the “NOx Dp/Foo” value (i.e., the gaseous emissions mass in grams (Dp) of NOx emitted by the gas turbine engine, divided by the rated output (Foo) of the engine in kilonewtons). The NOx Dp/Foo values for production aircraft engines at a specified static thrust, sometimes called “nameplate rated thrust”, are indicated in a publicly available International Civil Aviation Organization (ICAO) databank. For example, the ICAO Aircraft Engine Emissions Databank contains information on NOx Dp/Foo values of production turbojet and turbofan engines with a static thrust greater than 26.7 kilonewtons measured according to the procedures in ICAO Annex 16, Volume II.

When evaluating a new engine design, the NOx generation value of the new design will preferably be lower than the NOx generation value for an immediate predecessor or prior generation turbine engine. The NOx generation value of the new design (designated “NOx Dp/Foo_{new}”) can be compared to the NOx generation value for a predecessor turbine engine (designated “NOx Dp/Fooₚᵣᵢₒᵣ”). The DPFR can be expressed as:

$$DPFR = \frac{\frac{{NO}_{x} {D}_{p}}{{Foo}_{prior}}}{\frac{{NO}_{x} {D}_{p}}{{Foo}_{new}}} \qquad Expression ( 3 )$$

wherein a DPFR value greater than 1 is indicative of a new design gas turbine engine having an improved NOx emissions (i.e., lower) over the predecessor turbine engine. NOx emissions tend to be difficult to control because changes in engine design aimed at improving fuel efficiency often make it more challenging to limit NOx production. For example, increased flame temperature has further negative consequences because as the flame temperature increases, there is an increase in NOx emissions from the gas turbine engine exhaust. NOx emissions are one of the lesser desirable combustion byproducts, which are now regulated, and there is a desire to still further reduce NOx emissions. Since NOx emissions are a function of flame temperature, the NOx emissions can be used as an indicator of flame temperature, since, practically, there is currently no way to directly measure flame temperature.

Overall, there is a desire to reduce flame temperature as it will correspondingly reduce the NOx emissions and reduce the harsh thermal environment seen by the first stage turbine nozzle. Reducing flame temperature could be accomplished by having more compressor airflow through the combustor, which could be accomplished by reducing compressor cooling air to the turbine, which would negatively impact durability, or increasing the capacity of the compressor to create more compressor air, which would negatively impact fuel efficiency. Alternatively, the OPR could be reduced, which would reduce the temperature seen by the first stage turbine nozzle and increase durability, but it would negatively impact fuel efficiency.

There is a complex tradeoff between durability of a first stage turbine nozzle and fuel efficiency of the engine. Factors that would increase durability (e.g., reducing OPR, reducing flame temperature, or increasing bypass cooling air) tend to decrease aerodynamic performance. A design dilemma is how to arrive at a desired durability of the first stage turbine nozzle without sacrificing aerodynamic performance.

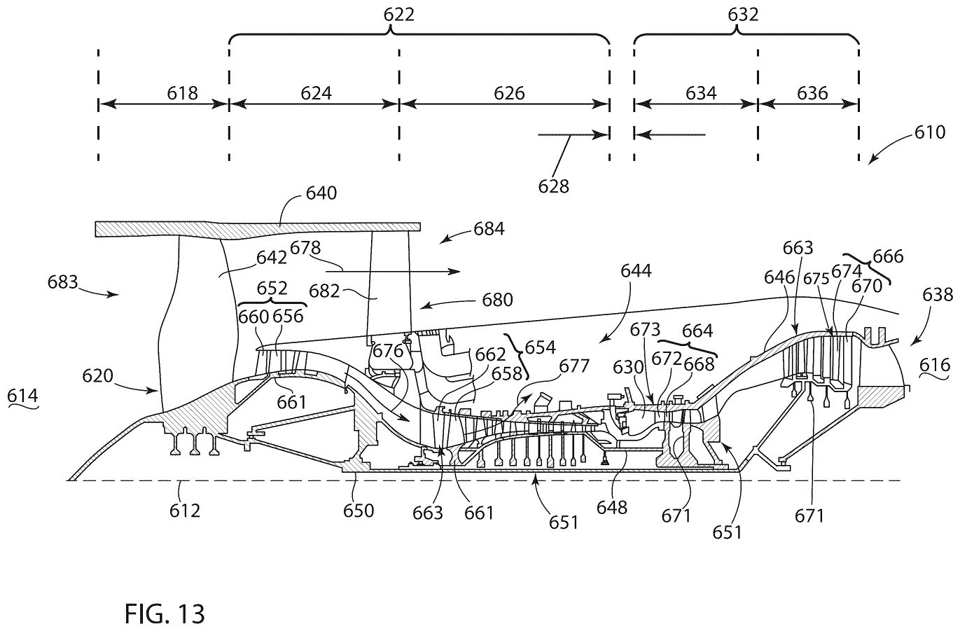

Exemplary solutions to this design dilemma are provided in the following examples, which are illustrated in the context of a turbine engine as shown in the schematic of FIG. 13. The turbine engine 610, as described herein, is meant as a non-limiting example, and other architectures are possible, such as, but not limited to, a steam turbine engine, a supercritical carbon dioxide turbine engine, or any other suitable turbine engine.

FIG. 13 is a schematic cross-sectional diagram of a gas turbine engine 610 for an aircraft that includes elements similar to those of the engine 100 illustrated in FIG. 8. The gas turbine engine 610 has a generally longitudinally extending axis or engine centerline 612 extending forward 614 to aft 616. The gas turbine engine 610 includes, in downstream serial flow relationship, a fan section 618 including a fan 620, a compressor section 622 including a booster or low pressure (LP) compressor 624 and a high pressure (HP) compressor 626, a combustion section 628 including a combustor 630, a turbine section 632 including a HP turbine 634, and a LP turbine 636, and an exhaust section 638.

The fan section 618 includes a fan casing 640 surrounding the fan 620. The fan 620 includes a plurality of fan blades 642 disposed radially about the engine centerline 612. A fan inlet 683 of the fan section 618 is defined at the upstream or forward end 614 of the gas turbine engine 610. A fan exhaust 684 is defined at the downstream end of the fan casing 640. The HP compressor 626, the combustor 630, and the HP turbine 634 form a core 644 of the gas turbine engine 610, which generates combustion gases. The engine core 644 is surrounded by a core casing 646, which can be coupled with the fan casing 640.

A HP shaft or spool 648 disposed coaxially about the engine centerline 612 of the gas turbine engine 610 drivingly connects the HP turbine 634 to the HP compressor 626. A LP shaft or spool 650, which is disposed coaxially about the engine centerline 612 of the gas turbine engine 610 within the larger diameter annular HP spool 648, drivingly connects the LP turbine 636 to the LP compressor 624 and fan 620. The spools 648, 650 are rotatable about the engine centerline 612 and couple to a plurality of rotatable elements, which can collectively define a rotor 651.

The LP compressor 624 and the HP compressor 626 respectively include a plurality of compressor stages 652, 654, in which a set of compressor blades 656, 658 rotate relative to a corresponding set of static compressor vanes 660, 662 (also called a nozzle) to compress or pressurize the stream of fluid passing through the stage. In a single compressor stage 652, 654, multiple compressor blades 656, 658 can be provided in a ring and can extend radially outwardly relative to the engine centerline 612, from a blade platform to a blade tip, while the corresponding compressor vanes 660, 662 are positioned upstream of and adjacent to the rotating blades 656, 658. It is noted that the number of blades, vanes, and compressor stages shown in FIG. 13 were selected for illustrative purposes only, and that other numbers are possible.

The blades 656, 658 for a stage of the compressor can be mounted to a compressor disk 661, which is mounted to the corresponding one of the HP and LP spools 648, 650, with each stage having its own compressor disk 661. The blades 656, 658 may be part of a blisk, rather than being mounted to a disk. The vanes 660, 662 for a stage of the compressor can be mounted to the core casing 646 in a circumferential arrangement.

The HP turbine 634 and the LP turbine 636 respectively include a plurality of turbine stages 664, 666, in which a set of turbine blades 668, 670 are rotated relative to a corresponding nozzle 673, 675 including respective sets of static turbine vanes 672, 674, to extract energy from the stream of fluid passing through the turbine stage 664, 666. In a single turbine stage 664, 666, multiple turbine blades 668, 670 can be provided in a ring and can extend radially outwardly relative to the engine centerline 612, from a blade platform to a blade tip, while the corresponding turbine vanes 672, 674 are positioned upstream of and adjacent to the rotating turbine blades 668, 670. The turbine blades 668, 670 and the turbine vanes 672, 674 can be airfoil shaped. It is noted that the number of blades, vanes, and turbine stages shown in FIG. 13 were selected for illustrative purposes only, and that other numbers are possible.

The turbine blades 668, 670 for a stage of the turbine can be mounted to a turbine disk 671, which is mounted to the corresponding one of the HP and LP spools 648, 650, with each stage having a dedicated turbine disk 671. The vanes 672, 674 for a stage of the compressor can be mounted to the core casing 646 in a circumferential arrangement.

Complimentary to the rotor portion, the stationary portions of the gas turbine engine 610, such as the vanes 660, 662, 672, 674 among the compressor and turbine sections 622, 632 are also referred to individually or collectively as a stator 663. As such, the stator 663 can refer to the combination of non-rotating elements throughout the gas turbine engine 610.

In operation, the airflow exiting the fan section 618 is split such that a portion of the airflow is channeled into the LP compressor 624, which then supplies pressurized airflow 676 to the HP compressor 626, which further pressurizes the air. The pressurized airflow 676 from the HP compressor 626 is mixed with fuel in the combustor 630 and ignited, thereby generating combustion gases. Some work is extracted from these gases by the HP turbine 634, which drives the HP compressor 626. The combustion gases are discharged into the LP turbine 636, which extracts additional work to drive the LP compressor 624, and the exhaust gas is ultimately discharged from the gas turbine engine 610 via the exhaust section 638. The driving of the LP turbine 636 drives the LP spool 650 to rotate the fan 620 and the LP compressor 624.

A portion of the pressurized airflow 676 can be drawn from the compressor section 622 as bypass cooling air 677. The bypass cooling air 677 can be drawn from the pressurized airflow 676 and provided to engine components requiring cooling. The temperature of pressurized airflow 676 entering and exiting the combustor 630 is significantly increased. As such, cooling provided by the bypass cooling air 677 is supplied to downstream turbine components (e.g., a blade 668) being subjected to the heightened temperature environments.

A remaining portion of the airflow exiting the fan section, called a bypass airflow 678, bypasses the LP compressor 624 and engine core 644 and exits the gas turbine engine 610 through a stationary vane row, and more particularly an outlet guide vane assembly 680, comprising a plurality of airfoil guide vanes 682, at the fan exhaust 684. More specifically, a circumferential row of radially extending airfoil guide vanes 682 are utilized adjacent the fan section 618 to exert some directional control of the bypass airflow 678.

Some of the air supplied by the fan 620 can bypass the engine core 644 and be used for cooling of portions, especially hot portions, of the gas turbine engine 610, and/or used to cool or power other aspects of the aircraft. In the context of a turbine engine, the hot portions of the engine are normally downstream of the combustor 630, especially the turbine section 632. The HP turbine 634 is the hottest portion as it is directly downstream of the combustion section 628. Other sources of cooling fluid can be, but are not limited to, fluid discharged from the LP compressor 624 or the HP compressor 626.

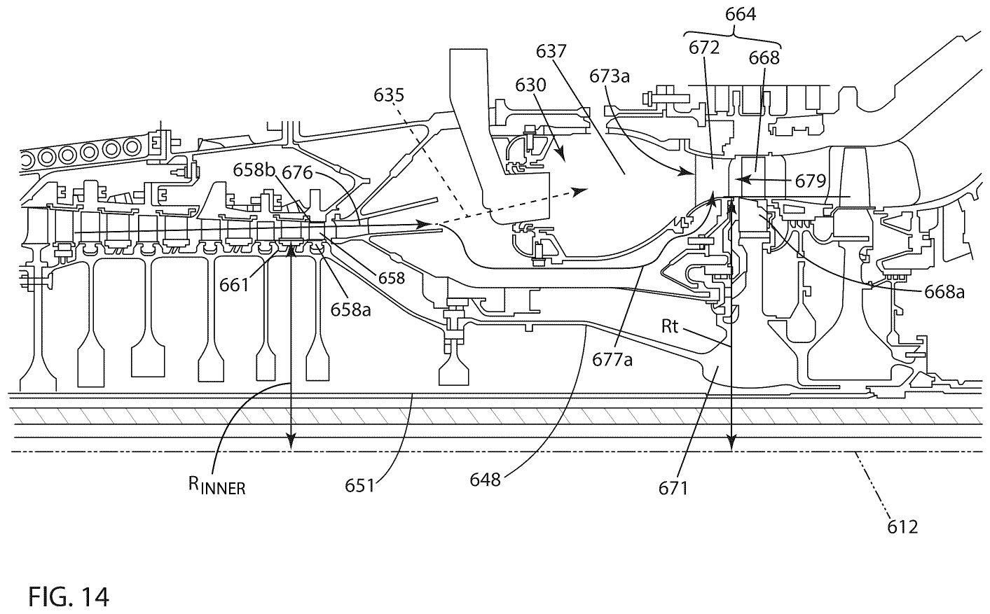

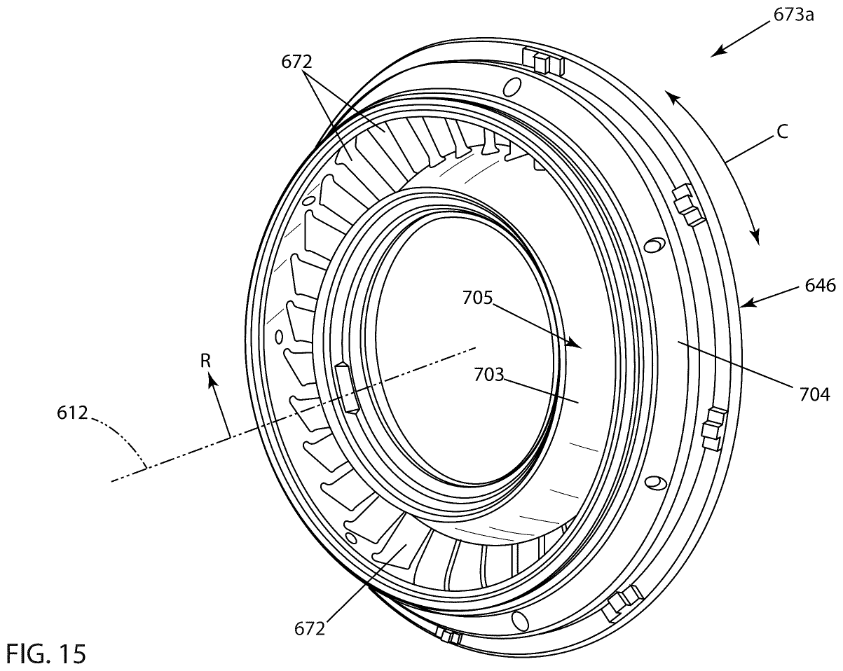

FIG. 14 is a schematic cross-sectional diagram illustrating a detail portion of a turbine engine in accordance with a non-limiting aspect, including the combustion section 628, the trailing or downstream end of the HP compressor section 622, and the leading or upstream end of the turbine section 632. As shown, the combustion section 628 is arranged downstream from the compressor section 622 to receive the pressurized airflow 676. The last or most downstream HP compressor stage 654 of the HP compressor 626 includes a respective set of compressor blades 658 coupled at a blade platform or hub 658a to the compressor disk 661. The set of compressor blades 658 extend radially outward relative to the engine centerline 612, to a blade tip 658b. In the illustrated example of engine 610, the inner radius (R_{INNNER}) can be measured as the distance from the last compressor blade hub 658a at a trailing edge of a corresponding compressor blade 658 to the engine centerline 612.

The turbine section 632 is arranged downstream from the combustion section 628 in order to receive the pressurized airflow 676 (including combustion gases) at a combustor outlet or exit 637. The first or most upstream HP turbine stage 664 of the turbine section 632 includes a first stage turbine nozzle 673a. The first stage turbine nozzle 673a is the most upstream turbine nozzle 673 and is disposed radially about the engine centerline 612. As such, the first stage turbine nozzle 673a is the closest turbine nozzle 673 to the combustion section 628. The first stage turbine nozzle exit 679, also referred to herein as the firing plane, is upstream of the corresponding first set of turbine blades 668. The first set of turbine blades 668 are coupled at a first turbine blade platform or hub 668a to the turbine disk 671 of the first HP turbine stage 664. A distance from the first turbine blade hub 668a at a leading edge of a corresponding turbine blade 668 to the engine centerline 612 defines a turbine blade leading hub radius (Rt).

As illustrated, the ratio of the turbine blade leading hub radius Rt to the inner radius R_{INNER} defines the core radius ratio CRR. The CRR can thus be expressed as:

$$CRR = \frac{Rt}{{R}_{INNER}} \qquad Expression ( 4 )$$

With the engine 610, the inner radius R_{INNER} can be the radius of the last compressor blade hub 658a.

In operation, a portion of the pressurized airflow 676 from the HP compressor 626 is supplied to the combustion section 628 for combustion with fuel (not shown) to generate combustion air (indicated as dashed arrow 635), which is fed to the turbine section 632 as the pressurized airflow 676. Some of the bypass cooling air 677a can be provided to portions of the turbine section 632 (e.g., to the first stage turbine nozzle 673a) for local cooling, such as film cooling, or injected into the combustion air 635 just upstream of the turbine section 632 to cool the combustion air 635 by dilution. The bypass cooling air 677a can, for example, be provided via a cooled cooling air system (see, e.g., cooled cooling air system 250 of FIGS. 8-11)

The temperature of the air at the first stage turbine nozzle exit 679 (i.e., the firing plane), can be determined at least in part by the temperature of the pressurized airflow 676, which includes the combustion air 635 from the combustor 630 and the temperature and volume of the bypass cooling air 677a provided to the first stage turbine nozzle 673a.

FIG. 15 illustrates a perspective view of the first stage turbine nozzle 673a, with other portions of the turbine section 632 (FIG. 13) omitted for clarity. The first stage turbine nozzle 673a is disposed radially about the engine centerline 612 and generally defines the radial direction R and the circumferential direction C.

The first stage turbine nozzle 673a can include an annular outer band 704 or wall that is spaced apart from an annular inner band 703 or wall along the radial direction R to define an annular airflow passage 705 surrounding the engine centerline 612. The first stage turbine nozzle 673a includes a respective set of turbine vanes 672. The set of turbine vanes 672 are circumferentially spaced with respect to each other about the first stage turbine nozzle 673a within the airflow passage 705 and extend radially outward between the inner band 703 and outer band 704. Each turbine vane 672 is coupled at a radially inner end (root) to the inner band 703, and further coupled at an opposing radially outer end (tip) to the outer band 704.

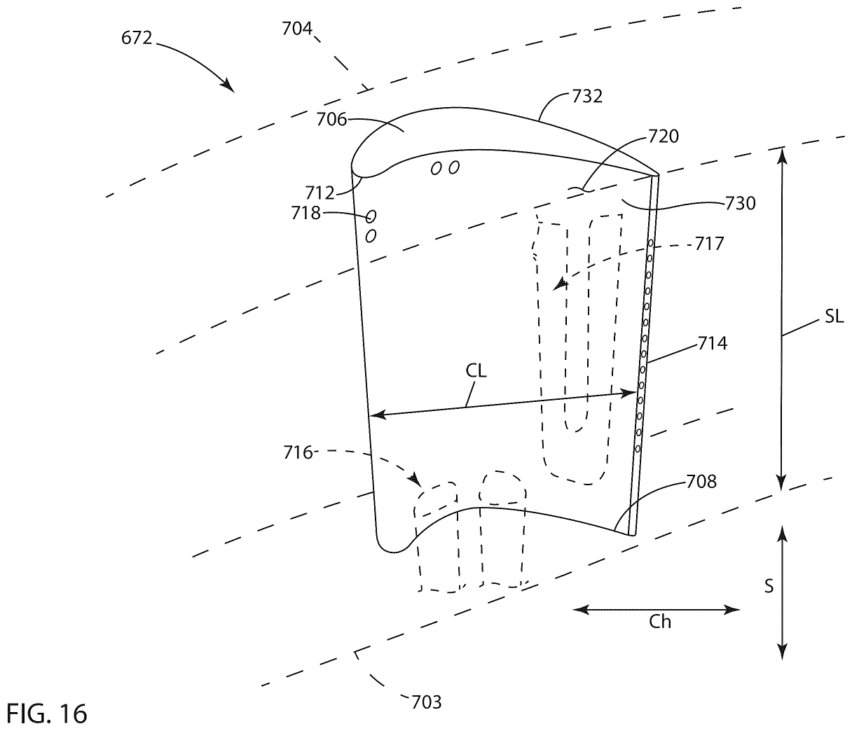

FIG. 16 is a schematic of an exemplary turbine vane 672 which can be in the shape of an airfoil. The turbine vane 672 includes an outer wall 720, which defines a pressure side 730 and a suction side 732. The outer wall 720 defines an entirety of an exterior of the turbine vane 672 along the pressure side 730 and the suction side 732. The outer wall 720 extends between a leading edge 712 and a trailing edge 714 to define a chord-wise dimension (denoted “Ch”), and also extends radially between a root 708 and a tip 706 to define a span-wise dimension (denoted “S”). A span length (denoted “SL”) is defined as the total length or height of the turbine vane 672 in the span-wise direction S from the root 708 to the tip 706. As illustrated, the chord length CL of the turbine vane 672 is the straight-line distance along the chordwise direction Ch between the leading edge 712 and the trailing edge 714. Because of the angular orientation of the airfoil shape of the turbine vane 672 relative to the engine centerline (FIG. 13) and the camber of the airfoil, the chord-wise direction generally is not parallel to the engine centerline.

The turbine vane 672 can be coupled to the annular inner band 703 (illustrated in dashed line) at the root 708 and to the annular outer band 704 (illustrated in dashed line) at the tip 706. A set of inlet passages 716, exemplarily shown as two inlet passages, can provide a path for communication for a fluid flow (e.g., bypass cooling air 677) to enter the turbine vane 672 from at least one of the annular inner band 703 or the annular outer band 704. Additionally, at least one cooling supply conduit 717 can be disposed within the turbine vane 672 and fluidly coupled to any one of the set of inlet passages 716.

A set of cooling holes 718 can extend through the outer wall 720. The cooling holes 718 are illustrated as being placed in various locations along the outer wall 720. The set of cooling holes 718 can be placed along the leading edge 712, the trailing edge 714, at the root 708 of the turbine vane 672, or near the tip 706 of the turbine vane 672. The set of cooling holes 718 can be located on the pressure side 730 or the suction side 732. The set of cooling holes 718 can be any number of cooling holes, where each cooling hole is fluidly coupled to the inlet passages 716 to cool the outer wall 720.

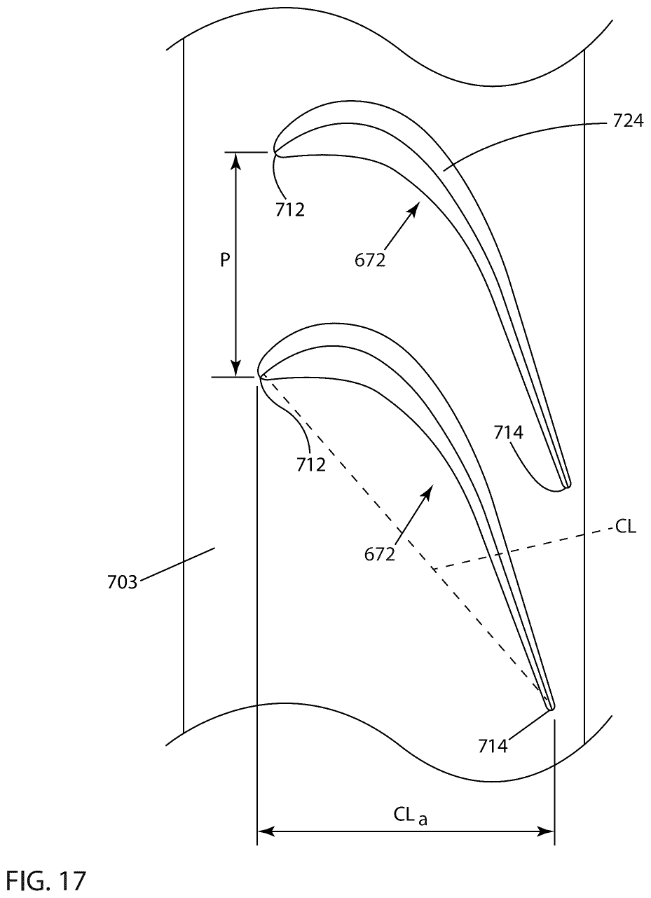

FIG. 17 is a cross-section top-down view of a portion of the first stage turbine nozzle 673a of FIG. 15. As shown, each turbine vane 672 can be defined by a profile 724 that influences efficiency characteristics. The profile 724 can be the same at the root 708 (FIG. 15) as it is at the tip 706 (FIG. 15). Alternatively, the profile 724 can be different at the root 708 than it is at the tip 706.

In non-limiting aspects, in the illustrated highly-cambered airfoil shape of the turbine vane 672, a majority of the chord length CL does not lay within the profile 724, but instead extends through the pressure side 730 area of the turbine vane 672.

Alternatively, none of, all of, or any fraction of the chord length CL may lay within the profile 724. In non-limiting aspects, each turbine vane 672 can have the same axial chord length CLa as the other turbine vanes 672 in the first stage turbine nozzle 673a. In other aspects, one or more of the turbine vanes 672 in the first stage turbine nozzle 673a can have a different axial chord length CLa than other turbine vanes 672 in the first stage turbine nozzle 673a. In such cases, the axial chord length CLa for the first stage turbine nozzle 673a can be calculated, for example as an average or representative axial chord length CLa value for the turbine vanes 672 of the first stage turbine nozzle 673a. In one non-limiting aspect, a representative axial chord length CLa for a first stage turbine nozzle 673a including the turbine vanes 672 having different respective axial chord lengths CLa can be calculated by determining the axial chord length CLa of each turbine vane 672 in the first stage turbine nozzle 673a, and then determining an average axial chord length CLa value for the turbine vanes 672 in the first stage turbine nozzle 673a.

In non-limiting aspects, the pitch P between adjacent turbine vanes 672 is constant throughout the first stage turbine nozzle 673a. In other aspects, the pitch P can vary between adjacent turbine vanes 672. A representative pitch P for a first stage turbine nozzle 673a having a non-constant distance between adjacent turbine vanes 672 can be calculated by determining a radial mid-point of each of the turbine vanes 672 along the respective leading edge 712, determining a radial mid-point circumference of the first stage turbine nozzle 673a defined by the determined radial mid-points of the turbine vanes 672, and dividing the determined radial mid-point circumference by the number of turbine vanes 672 in the first stage turbine nozzle 673a.

The determined pitch P and the axial chord length CLa values for the first stage turbine nozzle 673a together determine the solidity σ of the first stage turbine nozzle 673a. That is, the solidity σ of the first stage turbine nozzle 673a is defined by the ratio of the axial chord length CLa to the pitch P:

$$σ = \frac{{CL}_{a}}{P} \qquad Expression ( 5 )$$

The solidity σ of the first stage turbine nozzle 673a can be reduced by increasing the circumferential pitch P (e.g., by reducing the number of turbine vanes 672), or by reducing the axial chord length CLa of the turbine vanes 672, or both. Reducing the solidity σ of the first stage turbine nozzle 673a leads to less total vane surface area and corners. More total vane surface area can retain more heat and require additional compressor cooling airflow.

As solidity σ decreases, less non-chargeable cooling air is needed because there is less surface area to cool. In addition, more compressor air can be channeled through the combustor. More compressor air through the combustor lowers the combustor exit temperature (for a fixed fuel flow and/or fixed firing plane temperature), which reduces the harshness of the thermal environment seen by the first stage turbine nozzle 673a.

Reducing the solidity σ of the first stage turbine nozzle 673a can reduce pressure losses and increase overall aerodynamic performance. However, reducing the solidity σ of the first stage turbine nozzle 673a beyond certain limits can reduce the aerodynamic performance of the first stage turbine nozzle 673a via higher aerodynamic losses in the passages between turbine vanes 672.

In order for the first turbine stage 664 to produce the required power, the first stage turbine nozzle 673a needs to pre-condition the incoming pressurized airflow 676 by accelerating the pressurized airflow 676 at the combustor exit 637 to a relatively high Mach number (for example, around 0.9) with high angular momentum suitable for the anticipated rotational speed of the blades 668. The blades 668 then extract work from that high angular momentum.

If the first stage turbine nozzle 673a vane solidity σ is reduced by reducing the number of turbine vanes 672, there are fewer turbine vanes 672 to produce the angular momentum. Further, as solidity σ decreases, whether by reducing the number of turbine vanes 672, or by reducing the axial chord length CLa, or both, the turbine vanes 672 can become overloaded, not function as an airfoil, and fail to produce the correct angular momentum in the working airflow.

The inventors found the CRR relates to the ability of the turbine section 632 as a whole, and the first stage turbine nozzle 673a in particular, to be effectively cooled by the bypass cooling air 677a while maintaining required aerodynamic performance and fuel efficiency of the engine. The inventors discovered that there is a tradeoff between aerodynamic performance and durability of the turbine vanes 672 and blades 668 in the first HP turbine stage 664 due to the relationship of the length of the turbine vanes 672 and blades 668, and the amount of bypass cooling air 677a provided to the first stage turbine nozzle 673a.

For example, as the turbine vanes 672 become taller, by increasing the span length SL (i.e., decreasing the CRR), the vanes become more difficult to cool due to their inherent additional surface area. That is, taller turbine vanes 672 will be less durable unless the bypass cooling air 677a to the vanes is increased. To maintain durability D for taller turbine vanes 672, additional bypass cooling air 677a can be bled off from the pressurized airflow 676 and routed to the turbine vanes 672 to provide an adequate heat sink to protect the material forming the turbine vanes 672 from overheating. However, for a fixed firing plane temperature, reducing the pressurized airflow 676 by bleeding off more bypass cooling air 677a to cool the turbine vanes 672 results in increased flame temperatures in the combustor 630. The increased flame temperatures create an adverse thermal environment that can result in reduced durability of the first stage turbine nozzle 673a and reduced aerodynamic performance of the gas turbine engine 610.

Conversely, as the turbine vanes 672 become shorter, by decreasing the span length SL while keeping the airflow passage 705 dimensions fixed, (i.e., increasing the CRR), the turbine vanes 672 become easier to cool due to their inherent decreased surface area. That is, shorter turbine vanes 672 will be more durable with decreased span length SL.

With the foregoing in mind, the inventors sought to find a desired trade-off between durability of the first stage turbine nozzle 673a, and operational performance of the engine while satisfying all mission/performance requirements for the architecture. It was desirable to yield a more durable first stage turbine nozzle 673a without sacrificing fuel efficiency, and operational performance, or exceeding a permissible Nox emission requirement of the gas turbine engine. As described in more detail below, the inventors determined, based on the conclusions reached after evaluating different engine configurations, interdependent relationships exist among various parameters, including the number N of turbine stages, solidity σ, OPR, CRR, and DPFR values, in those embodiments that exhibited the sought-after trade-off between aerodynamic performance and durability of a turbine nozzle.

The inventors conceived, tested, and evaluated several numbers of, and different types of, engine configurations. Each engine configuration may have various different mission and performance requirements. Each engine configuration included a number “N” of turbine stages, solidity σ, an overall pressure ratio OPR, a core radius ratio CRR, and a DPFR value. While some of the different engine configurations exhibited the sought-after trade-off between aerodynamic performance and durability of a turbine nozzle, not all did. A partial listing of values corresponding to different engine configurations including certain embodiments that exhibited the sought-after trade-off between aerodynamic performance and durability of a turbine nozzle is shown in TABLE 1.

TABLE 1

| DPFR | Solidity | N | OPR | CRR |
|---|---|---|---|---|
| 0.8 | 0.2 | 2 | 20 | 0.9 |
| 1 | 0.2 | 2 | 30 | 1 |
| 1.2 | 0.2 | 2 | 40 | 1.1 |
| 1.6 | 0.2 | 2 | 50 | 1.2 |
| 2 | 0.2 | 2 | 60 | 1.3 |
| 0.8 | 0.3 | 2 | 20 | 0.9 |
| 1 | 0.3 | 2 | 30 | 1 |
| 1.2 | 0.3 | 2 | 40 | 1.1 |
| 1.6 | 0.3 | 2 | 50 | 1.2 |
| 2 | 0.3 | 2 | 60 | 1.3 |
| 0.8 | 0.4 | 2 | 30 | 1.1 |
| 1 | 0.4 | 2 | 40 | 1.2 |
| 1.2 | 0.4 | 2 | 50 | 1.3 |
| 1.6 | 0.4 | 2 | 60 | 0.9 |
| 2 | 0.4 | 2 | 20 | 1 |
| 0.8 | 0.6 | 2 | 40 | 1.3 |
| 1 | 0.6 | 2 | 50 | 0.9 |
| 1.2 | 0.6 | 2 | 60 | 1 |
| 1.6 | 0.6 | 2 | 20 | 1.1 |
| 2 | 0.6 | 2 | 30 | 1.2 |
| 0.8 | 0.8 | 2 | 50 | 1 |
| 1 | 0.8 | 2 | 60 | 1.1 |
| 1.2 | 0.8 | 2 | 20 | 1.2 |
| 1.6 | 0.8 | 2 | 30 | 1.3 |
| 2 | 0.8 | 2 | 40 | 0.9 |
| 0.8 | 1 | 2 | 60 | 1.2 |
| 1 | 1 | 2 | 20 | 1.3 |
| 1.2 | 1 | 2 | 30 | 0.9 |
| 1.6 | 1 | 2 | 40 | 1 |
| 2 | 1 | 2 | 50 | 1.1 |
| 2 | 0.4 | 1 | 20 | 1 |
| 2 | 0.6 | 1 | 30 | 1.2 |

During this extensive and time-consuming analysis, the inventors discovered interdependent relationships as described below that enable the balance needed to satisfy durability while maintaining aerodynamic performance.

For example, the inventors determined that within a certain, limited range of acceptable reductions in a solidity σ of a first stage turbine nozzle 673a, there results an unexpected increase in the durability of the nozzle 673a without significant penalty in aerodynamic performance. The inventors determined that a reduction in the solidity σ of the first stage turbine nozzle 673a of satisfactory new designs can result in an increase in the durability without unacceptable penalties.

The inventors also found the durability of satisfactory new designs of the first stage turbine nozzle 673a can have a positive correlation to CRR. The inventors further discovered a relationship between the durability of the turbine section and the OPR of the engine. As the engine OPR is increased, which typically increases system performance, the compressor exit temperature increases, which in turn reduces the heat sink capacity of the cooling air supplied to the turbine, reducing the durability of the turbine. In their discovery, the inventors found the durability of the first stage turbine nozzle 673a of satisfactory new designs has a positive correlation to a ratio of the integer number of turbine stages N and the OPR of the engine.

The inventors were able to quantify the discovered relationship amongst the parameters for the embodiments that exhibited the sought-after trade-off between aerodynamic performance and durability of a turbine nozzle. The unexpectedly discovered relationship was found by identifying certain features, including those discussed above, common among the different engine architectures that provided the desired trade between performance and durability. The inventors call it the nozzle Durability Performance Index (denoted “DPI”) and expressed as:

$$DPI = √ ( 1 / σ ) * √ DPFR * ( 1.275 * N \div 〚 OPR 〛 \hat{} ( 0.275 ) ) ) * ( 1 - 3 * ( σ - 0.6 ) \hat{} 2 ) * √ ( CRR ) \qquad Expression ( 6 )$$

This DPI expression can be simplified to:

$$DPI = \sqrt{\frac{CRR * DPFR}{σ}} * [ \frac{1.275 * N}{{OPR}^{0.275}} ] * [ 1 - 3 * {( σ - 0.6 )}^{2} ] \qquad Expression ( 7 )$$

For example, TABLE 2, below, illustrates the DPI values for the engine configurations of TABLE 1.

TABLE 2

| DPFR | Solidity | N | OPR | CRR | DPI |
|---|---|---|---|---|---|
| 1.2 | 0.2 | 2 | 40 | 1.1 | 1.235 |
| 1.6 | 0.2 | 2 | 50 | 1.2 | 1.401 |
| 2 | 0.2 | 2 | 60 | 1.3 | 1.550 |
| 0.8 | 0.3 | 2 | 20 | 0.9 | 1.265 |
| 1 | 0.3 | 2 | 30 | 1 | 1.333 |
| 1.2 | 0.3 | 2 | 40 | 1.1 | 1.415 |
| 1.6 | 0.3 | 2 | 50 | 1.2 | 1.605 |
| 2 | 0.3 | 2 | 60 | 1.3 | 1.777 |
| 0.8 | 0.4 | 2 | 30 | 1.1 | 1.306 |
| 1 | 0.4 | 2 | 40 | 1.2 | 1.409 |
| 1.2 | 0.4 | 2 | 50 | 1.3 | 1.511 |
| 1.6 | 0.4 | 2 | 60 | 0.9 | 1.380 |
| 2 | 0.4 | 2 | 20 | 1 | 2.201 |
| 0.8 | 0.6 | 2 | 40 | 1.3 | 1.217 |
| 1.6 | 0.6 | 2 | 20 | 1.1 | 1.916 |
| 2 | 0.6 | 2 | 30 | 1.2 | 2.001 |
| 1.2 | 0.8 | 2 | 20 | 1.2 | 1.320 |
| 1.6 | 0.8 | 2 | 30 | 1.3 | 1.420 |
| 2 | 0.8 | 2 | 40 | 0.9 | 1.220 |
| 2 | 0.2 | 2 | 20 | 0.9 | 1.745 |
| 2 | 0.4 | 1 | 20 | 1 | 1.100 |
| 2 | 0.6 | 1 | 30 | 1.2 | 1.001 |
| 1.8 | 0.4 | 1 | 20 | 1.1 | 1.095 |
| 2 | 0.4 | 1 | 30 | 1.2 | 1.079 |
| 2 | 0.4 | 1 | 20 | 1 | 1.101 |

The inventors determined that when compared to prior art designs, the exemplary gas turbine engines having a DPI greater than 1.001 and less than 2.201 exhibited a more durable first stage turbine nozzle 673a while maintaining satisfactory aerodynamic performance. Furthermore, in addition to increased durability of the first stage turbine nozzle 673a, the illustrated exemplary aspects can unexpectedly provide improved engine performance, for example a reduced Nox emissions (as indicated by a DPFR greater than 1) over prior engines having the same power output.

TABLE 3, below, provides the ranges of parameter values for gas turbine engines exhibiting the sought-after trade-off between aerodynamic performance and durability of a turbine nozzle. When the engine under consideration has features that fall within these ranges and result in DPI within the desired range (as discussed above), then it indicates a durability improvement for the first stage turbine nozzle 673a itself and performance improvements discussed earlier.

TABLE 3

| Parameter | First Range | Second Range | Third Range |
|---|---|---|---|
| DPI | 1.001-2.201 | 1.217-2.201 | 1.001-1.1000 |
| σ | 0.2-0.8 | 0.2-0.8 | 0.4-0.6 |
| DPFR | 0.8-2.0 | 0.8-2.0 | 1.8-2 |
| OPR | 20-60 | 20-60 | 20-30 |
| CRR | 0.9-1.3 | 0.9-1.3 | 1.0-1.2 |
| N | 1-2 | 2 | 1 |

It was further discovered, unexpectedly, by the inventors, that a first stage turbine nozzle 673a having an improved durability over prior designs where the first stage turbine nozzle 673a to has a solidity σ that lies within a range between 0.2 and 0.8, inclusively (i.e., 0.2≤σ≤0.8). The inventors found a high aerodynamic performance in satisfactory designs having a solidity σ of 0.8. The inventors further found the aerodynamic performance would diminish as solidity σ was decreased. However, the inventors found that a reduction in aerodynamic performance was offset by increases in the durability of the first stage turbine nozzle 673a within the limited ranges given above. Designs having the first stage turbine nozzle 673a with a solidity a in the range between 0.2 and 0.8, inclusive, was determined by the inventors to provide satisfactory durability and aerodynamic performance.

Finding a workable solution that balances durability of the first stage turbine nozzle and the fuel efficiency performance of the gas turbine engine is a labor-intensive and time-intensive process, because the process is iterative and involves the balancing of interdependent variable parameters. Design procedures frequently require placing the first stage turbine nozzle 673a (FIG. 14) into a gas turbine engine 610 (FIG. 13) designed for specific performance parameters within an acceptable range and evaluating a durability of the first stage turbine nozzle 673a based on a particular set of those performance parameters. Evaluating whether the durability of the first stage turbine nozzle 673a is positively or negatively affected by operation of the gas turbine engine 610 based on other performance parameters within the acceptable range, is time-intensive. In some cases, this may even result in a re-design of the first stage turbine nozzle 673a and gas turbine engine 610 if predetermined performance parameters (e.g., durability, fuel efficiency, and the like) for the new gas turbine engine 610 are not met. It is desirable to have an ability to arrive at an improved first stage turbine nozzle 673a, rather than relying on chance or extensive experimentation. It would be desirable to have a limited or narrowed range of possible first stage turbine nozzle 673a configurations that meet improved durability requirements, while also meeting predetermined design parameters of the engine, such parameters including DPFR, OPR, CRR, solidity and performance parameters such as Nox emissions.

Knowing these trade-offs and relationships is a desirable time saver. Moreover, utilizing the above-described relationships and DPI equation, the inventors found that the number of suitable or feasible first stage turbine nozzle possibilities for placement in a turbine engine that is capable of meeting the design requirements could be greatly reduced, thereby facilitating a more rapid down-selection of turbine nozzles to consider as an engine is being developed. Such benefit provides more insight to the requirements for a given engine long before specific technologies, integration, or system requirements are developed fully.

Other benefits associated with the DPI described herein may include a preliminary assessment of design parameters in terms of the first stage turbine nozzle. Further, the DPI described herein enables an early visualization of tradeoffs in terms of various geometries that are bounded by the constraints imposed by the materials used, the available space in the gas turbine engine, the type of turbine engine or number of stages, or any other design constraint. The DPI enables the manufacturing of a high performing turbine engine with the factors available. While narrowing these multiple factors to a region of possibilities saves time, money, and resources, the largest benefit is at the system level, where the turbine nozzle described herein enables improved system performance. Previously developed turbine nozzles may peak in one area of performance by design, but lose efficiency or lifetime benefits in another area of performance. In other words, the DPI enables the development and production of higher performing turbine engines across multiple performance metrics within a given set of constraints. The improved turbine nozzle designs defined by the DPI account for these factors and desirable outcomes.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine comprising: a turbomachine comprising a compressor section, a combustion section, and a turbine section arranged in serial flow order, the compressor section having a high pressure compressor defining a high pressure compressor exit area (A_{HPCExit}) in square inches; wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific determined as follows: Fn_{Total}×EGT/(A_{HPCExit}²×1000).

The gas turbine engine of the preceding clauses wherein the corrected specific thrust is from 42 to 90, such as from 45 to 80, such as from 50 to 80.

The gas turbine engine of the preceding clauses, wherein the EGT is greater than 1000 degrees Celsius and less than 1300 degrees Celsius.

The gas turbine engine of any preceding clause, wherein the EGT is greater than 1100 degree Celsius and less than 1250 degrees Celsius.

The gas turbine engine of any preceding clause, wherein the EGT is greater than 1150 degree Celsius and less than 1250 degrees Celsius.

The gas turbine engine of any preceding clause, wherein the EGT is greater than 1000 degree Celsius and less than 1300 degrees Celsius, and wherein the corrected specific thrust is greater than or equal to 45.

The gas turbine engine of any preceding clause, wherein the EGT is greater than 1000 degree Celsius and less than 1300 degrees Celsius, and wherein the corrected specific thrust is greater than or equal to 50.

The gas turbine engine of any preceding clause, wherein the turbine section comprises a high pressure turbine having a first stage of high pressure turbine rotor blades, and wherein the gas turbine engine further comprises: a cooled cooling air system in fluid communication with the first stage of high pressure turbine rotor blades.

The gas turbine engine of one or more of the preceding clause, wherein the cooled cooling air system is further in fluid communication with the high pressure compressor for receiving an airflow from the high pressure compressor, and wherein the cooled cooling air system further comprises a heat exchanger in thermal communication with the airflow for cooling the airflow.

The gas turbine engine of any preceding clause, wherein when the gas turbine engine is operated at a takeoff power level, the cooled cooling air system is configured to provide a temperature reduction of a cooling airflow equal to at least 15% of the EGT and up to 45% of the EGT.

The gas turbine engine of any preceding clause, wherein when the gas turbine engine is operated at a takeoff power level, the cooled cooling air system is configured to receive between 2.5% and 35% of an airflow through a working gas flowpath of the turbomachine at an inlet to a compressor of the compressor section.

The gas turbine engine of any preceding clause, further comprising a primary fan driven by the turbomachine.

The gas turbine engine of any preceding clause, further comprising an inlet duct downstream of the primary fan and upstream of the compressor section of the turbomachine; and a secondary fan located within the inlet duct.

The gas turbine engine of any preceding clause, wherein the gas turbine engine defines a bypass passage over the turbomachine, and wherein the gas turbine engine defines a third stream extending from a location downstream of the secondary fan to the bypass passage.

The gas turbine engine of any preceding clause, wherein the secondary fan is a single stage secondary fan.

A method of operating a gas turbine engine, comprising: operating the gas turbine engine at a takeoff power level, the gas turbine engine having a turbomachine with a high pressure compressor defining a high pressure compressor exit area (A_{HPCExit}) in square inches, the gas turbine engine defining a redline exhaust gas temperature (EGT) in degrees Celsius, a total sea level static thrust output (Fn_{Total}) in pounds, and a corrected specific thrust; wherein the corrected specific thrust is greater than or equal to 42 and less than or equal to 90, the corrected specific determined as follows: Fn_{Total}×EGT/(A_{HPCExit}²×1000).

The method of any preceding clause, wherein the EGT defined by the gas turbine engine is greater than 1000 degree Celsius and less than 1300 degrees Celsius.

The method of any preceding clause, wherein the EGT defined by the gas turbine engine is greater than 1100 degree Celsius and less than 1300 degrees Celsius.

The method of any preceding clause, wherein the EGT defined by the gas turbine engine is greater than 1000 degree Celsius and less than 1300 degrees Celsius, and wherein the corrected specific thrust defined by the gas turbine engine is greater than or equal to 45.

The method of any preceding clause, wherein operating the gas turbine engine at the takeoff power level further comprises reducing a temperature of a cooling airflow provided to a high pressure turbine of the gas turbine engine with a cooled cooling air system.

The method of any preceding clause, wherein reducing the temperature of the cooling airflow provided to the high pressure turbine of the gas turbine engine with the cooled cooling air system comprises providing a temperature reduction of the cooling airflow equal to at least 15% of the EGT and up to 45% of the EGT.

The gas turbine engine of any preceding clause, wherein the cooled cooling air systems includes a thermal bus cooled cooling air system (see, e.g., FIGS. 4 and 5).

The gas turbine engine of any preceding clause, wherein the cooled cooling air systems includes a dedicated heat exchanger cooled cooling air system (i.e., a cooled cooling air system including a heat exchanger dedicated to the cooled cooling air system).

The gas turbine engine of any preceding clause, wherein the cooled cooling air systems includes a bypass heat exchanger cooled cooling air system having a heat sink heat exchanger thermally coupled to an airflow through a bypass passage (see, e.g., FIG. 9).

The gas turbine engine of any preceding clause, wherein the cooled cooling air systems includes an air-to-air cooled cooling air system (a cooled cooling air system having a heat sink heat exchanger configured to transfer heat to an airflow; see, e.g., FIG. 9.

The gas turbine engine of any preceding clause, wherein the cooled cooling air systems includes an oil-to-air cooled cooling air system (a cooled cooling air system having a heat sink heat exchanger configured to transfer heat to an oil flow).

The gas turbine engine of any preceding clause, wherein the cooled cooling air systems includes a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc., or a combination thereof; see, e.g., FIG. 4).

The gas turbine engine of any preceding clause, wherein the cooled cooling air system is configured to receive the cooling air from a downstream end of a high pressure compressor.

The gas turbine engine of any preceding clause, wherein the cooled cooling air systems is configured to receive the cooling air from an upstream end of the high pressure compressor.

The gas turbine engine of any preceding clause, wherein the cooled cooling air systems is configured to receive the cooling air from a downstream end of a low pressure compressor.

The gas turbine engine of any preceding clause, wherein the cooled cooling air system is configured to receive the cooling air from an upstream end of the low pressure compressor.

The gas turbine engine of any preceding clause, wherein the cooled cooling air systems is configured to receive the cooling air from a location between compressors.

The gas turbine engine of any preceding clause, wherein the cooled cooling air systems is configured to receive the cooling air from a bypass passage.

A turbine engine comprising: a core including a fan section, a compressor section, a combustion section, and a turbine section in serial flow arrangement, the core defining an engine centerline; the compressor section including a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60; the turbine section including a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section; wherein the first stage turbine nozzle has a solidity (G) defined as a ratio of a representative axial chord length for the first stage turbine nozzle to a representative circumferential spacing between adjacent vanes of the first stage turbine nozzle, wherein the solidity is in a range of 0.2-0.8; wherein the gas turbine engine has a Nox Dp/Foo ratio (DPFR) defined as a ratio of a Nox Dp/Foo of a predecessor turbine engine to a Nox Dp/Foo of the gas turbine engine, wherein the DPFR is in a range of 0.8-2.0; wherein the turbine section and compressor section define a core radius ratio (CRR), the CRR defined as a ratio of Rt/R_{INNER}, where Rt is a radius defined by the first turbine stage and R_{INNER} is a radius defined by the last compressor stage, wherein the CRR is in a range of 0.9-1.3; and wherein the first stage turbine nozzle having a durability and performance index (DPI) defined as:

$$DPI = √ [ ( CRR * DPFR ) / σ ] * [ \frac{1.275 * N}{{OPR}^{0.275}} ] * [ 1 - 3 * {( σ - 0.6 )}^{2} ] ,$$

wherein the DPI is in the range of 1.001-2.201.

A turbine engine comprising: a core including a fan section, a compressor section, a combustion section, and a turbine section in serial flow arrangement, the core defining an engine centerline; the compressor section including a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60; the turbine section including a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section; wherein the first stage turbine nozzle has a solidity (σ) defined as a ratio of an axial chord length of a first stage vane to a circumferential spacing between adjacent vanes of the first stage turbine nozzle, wherein the solidity is in a range of 0.2-0.8; wherein the gas turbine engine has a Nox Dp/Foo ratio (DPFR) defined as a ratio of a Nox Dp/Foo of a predecessor turbine engine to the Nox Dp/Foo of the gas turbine engine, wherein the DPFR is in a range of 0.8-2.0; wherein the turbine section and compressor section define a core radius ratio (CRR), the CRR defined as a ratio of Rt/R_{INNER}, where Rt is a radius defined by the first turbine stage and R_{INNER} is a radius defined by the last compressor stage, wherein the CRR is in a range of 0.9-1.3; and wherein the first stage turbine nozzle having a durability and performance index (DPI) defined as:

$$DPI = √ [ ( CRR * DPFR ) / σ ] * [ ( 1.275 * N ) / 〚 OPR 〛 \hat{} 0.275 ] * [ 1 - 3 * 〚 ( σ - 0.6 ) 〛 \hat{} 2 ] \\ wherein the DPI is in the range of 1.001 - 2.201 .$$

A gas turbine engine comprising: a turbomachine comprising a compressor section, a combustion section, and a turbine section arranged in serial flow order, the compressor section having a high pressure compressor defining a high pressure compressor exit area (A_{HPCExit}) in square inches; wherein the turbine section and the compressor section define a core radius ratio (CRR), the CRR defined as a ratio of Rt/R_{INNER}, where Rt is a radius defined by a first turbine stage of the turbine section and R_{INNER} is a radius defined by a last compressor stage of the high pressure compressor, wherein the CRR is in a range of 0.9-1.3; and wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

A gas turbine engine comprising: a turbomachine comprising a compressor section, a combustion section, and a turbine section arranged in serial flow order, the compressor section having a high pressure compressor defining a high pressure compressor exit area (A_{HPCExit}) in square inches; wherein the gas turbine engine has a Nox Dp/Foo ratio (DPFR) defined as a ratio of a Nox Dp/Foo of a predecessor turbine engine to a Nox Dp/Foo of the gas turbine engine, wherein the DPFR is in a range of 0.8-2.0; and wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

A gas turbine engine comprising: a turbomachine comprising a fan section, a compressor section, a combustion section, and a turbine section arranged in serial flow order, the compressor section having a high pressure compressor defining a high pressure compressor exit area (A_{HPCExit}) in square inches; the compressor section including a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60; and wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

The gas turbine engine of any preceding clause, wherein the gas turbine engine has a Nox Dp/Foo ratio (DPFR) defined as a ratio of a Nox Dp/Foo of a predecessor turbine engine to a Nox Dp/Foo of the gas turbine engine, wherein the DPFR is in a range of 0.8-2.0.

The gas turbine engine of any preceding clause, wherein the turbomachine further comprises a fan section; and wherein the compressor section includes a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60.

The gas turbine engine of any preceding clause, wherein the turbine section includes a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section.

The gas turbine engine of any preceding clause, wherein the first stage turbine nozzle has a solidity (σ) defined as a ratio of a representative axial chord length for the first stage turbine nozzle to a representative circumferential spacing between adjacent vanes of the first stage turbine nozzle, wherein the solidity is in a range of 0.2-0.8.

The gas turbine engine of any preceding clause, wherein the first stage turbine nozzle has a durability and performance index (DPI) defined as:

$$DPI = √ [ ( CRR * DPFR ) / σ ] * [ \frac{1.275 * N}{{OPR}^{0.275}} ] * [ 1 - 3 * {( σ - 0.6 )}^{2} ] ,$$

wherein the DPI is in the range of 1.001-2.201.

The gas turbine engine of any preceding clause, wherein: 1.217≤DPI≤2.201; and N=2.

The turbine engine of any preceding clause, wherein: 1.217≤DPI≤2.201; 0.2≤≤0.8; 0.8≤DPFR≤2.0; 20≤OPR≤60; 0.9≤CRR≤1.3; and N=2.

The turbine engine of any preceding clause, wherein at least one of: 1.217≤ DPI≤2.201; 0.2≤σ≤0.8; 0.8≤DPFR≤2.0; 20≤OPR≤60; 0.9≤CRR≤1.3; or N=2.

The gas turbine engine of any preceding clause, wherein: 1.001≤DPI≤1.1; 0.4≤σ≤0.6; 1.8≤DPFR≤2; 20≤OPR≤30; 1.0≤CRR≤1.2; and 1000<EGT<1300 degrees Celsius.

The gas turbine engine of any preceding clause, wherein at least one of: 1.001≤DPI≤1.1; 0.4<<0.6; 1.8≤DPFR≤2; 20≤OPR≤30; 1.0≤CRR≤1.2; or 1000≤EGT≤1300 degrees Celsius.

The gas turbine engine of any preceding clause, wherein the turbomachine further comprises a fan section; and wherein the compressor section includes a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60.

The gas turbine engine of any preceding clause, wherein the turbine section includes a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section.

The gas turbine engine of any preceding clause, wherein the first stage turbine nozzle has a solidity (σ) defined as a ratio of a representative axial chord length for the first stage turbine nozzle to a representative circumferential spacing between adjacent vanes of the first stage turbine nozzle, wherein the solidity is in a range of 0.2-0.8.

The gas turbine engine of any preceding clause, wherein: 0.4≤σ≤0.6; 1.8≤DPFR≤2; 20≤OPR≤30; and 1000≤EGT≤1300 degrees Celsius.

The gas turbine engine of any preceding clause, wherein the Nox Dp/Foo of the gas turbine engine is less than the Nox Dp/Foo of the predecessor turbine engine.

The gas turbine engine of any preceding clause, wherein the turbomachine further comprises a fan section; and wherein the compressor section includes a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60.

The gas turbine engine of any preceding clause, wherein the turbine section includes a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section.

The gas turbine engine of any preceding clause, wherein the first stage turbine nozzle has a solidity (σ) defined as a ratio of a representative axial chord length for the first stage turbine nozzle to a representative circumferential spacing between adjacent vanes of the first stage turbine nozzle, wherein the solidity is in a range of 0.2-0.8.

The gas turbine engine of any preceding clause, wherein the turbine section and the compressor section define a core radius ratio (CRR), the CRR defined as a ratio of Rt/R_{INNER}, where Rt is a radius defined by a first turbine stage of the turbine section and R_{INNER} is a radius defined by a last compressor stage of the high pressure compressor, wherein the CRR is in a range of 1.0-1.2.

The gas turbine engine of any preceding clause, wherein the turbine section and the compressor section define a core radius ratio (CRR), the CRR defined as a ratio of Rt/R_{INNER}, where Rt is a radius defined by a first turbine stage of the turbine section and R_{INNER} is a radius defined by a last compressor stage of the high pressure compressor, wherein the CRR is in a range of 0.9-1.3; and wherein the first stage turbine nozzle has a solidity (σ) defined as a ratio of a representative axial chord length for the first stage turbine nozzle to a representative circumferential spacing between adjacent vanes of the first stage turbine nozzle, wherein the solidity is in a range of 0.2-0.8.

The gas turbine engine of any preceding clause, wherein the OPR is determined based on a rated thrust of the gas turbine engine.

The gas turbine engine of any preceding clause, wherein at least one vane in the first stage turbine nozzle has a different axial chord length than other vanes in the first stage turbine nozzle.

The turbine engine of any preceding clause, wherein the axial chord length for the first stage turbine nozzle is calculated as a representative axial chord length for the vanes of the first stage turbine nozzle.

The gas turbine engine of any preceding clause, wherein the representative axial chord length for the first stage turbine nozzle is calculated based on an average axial chord length for the vanes in the first stage turbine nozzle.

The gas turbine engine of any preceding clause, wherein a circumferential spacing between adjacent vanes of the first stage turbine nozzle is determined as a representative pitch for the first stage turbine nozzle.

The gas turbine engine of any preceding clause, wherein the first stage turbine nozzle includes a non-constant circumferential spacing between adjacent vanes.

The gas turbine engine of any preceding clause, wherein the circumferential spacing between adjacent vanes of the first stage turbine nozzle is a non-constant circumferential spacing.

The gas turbine engine of any preceding clause, wherein the representative circumferential spacing between adjacent vanes for the first stage turbine nozzle is determined by determining a radial mid-point of each of the vanes in the first stage turbine nozzle along a respective leading edge, determining a radial mid-point circumference of the first stage turbine nozzle defined by the determined radial mid-points of the vanes in the first stage turbine nozzle, and dividing the determined radial mid-point circumference by the number of vanes in the first stage turbine nozzle.

The gas turbine engine of any preceding clause, wherein the representative pitch for the first stage turbine nozzle is determined by determining a radial mid-point of each of the vanes along a respective leading edge, determining a radial mid-point circumference of the first stage turbine nozzle defined by the determined radial mid-points of the vanes, and dividing the determined radial mid-point circumference by the number of turbine vanes in the first stage turbine nozzle.

The gas turbine engine of any preceding clause, wherein the NOx Dp/Foo of the predecessor turbine engine is indicated in an International Civil Aviation Organization (ICAO) Aircraft Engine Emissions Databank.

The gas turbine engine of any preceding clause, wherein the OPR is defined at a predetermined static thrust of the gas turbine engine.

The gas turbine engine of any preceding clause, wherein the predetermined static thrust is a nameplate rated thrust of the gas turbine engine.

The gas turbine engine of any preceding clause, wherein the radius Rt defined by the first turbine stage is based on a distance from a blade hub of the first turbine stage to the engine centerline.

The gas turbine engine of any preceding clause, wherein the radius R_{INNER} defined by the last compressor stage is based on a distance from a blade hub of the last compressor stage to the engine centerline.

The gas turbine engine of any preceding clause, wherein the respective chord lengths of the vanes in the first stage turbine nozzle are the same with respect to each other.

The gas turbine engine of any preceding clause, wherein the circumferential spacing between adjacent vanes of the first stage turbine nozzle is constant throughout the first stage turbine nozzle.

The gas turbine engine of any preceding clause, wherein at least one vane in the first stage turbine nozzle defines a set of inlet passages fluidly coupled with a cooling supply conduit disposed within the at least one vane.

The gas turbine engine of any preceding clause, wherein the set of inlet passages is arranged in fluid communication with a fluid flow.

The gas turbine engine of any preceding clause, wherein at least one vane in the first stage turbine nozzle includes an outer wall defining a set of cooling holes therethrough.

The gas turbine engine of any preceding clause, wherein each cooling hole is fluidly coupled to the set of inlet passages.

The gas turbine engine of any preceding clause, wherein the Nox Dp/Foo of the gas turbine engine is less than the Nox Dp/Foo of the predecessor turbine engine.

The gas turbine engine of any preceding clause, comprising a core including the fan section, the compressor section, the combustion section, and the turbine section in serial flow arrangement.

The gas turbine engine of any preceding clause, wherein the core defines an engine centerline.

The gas turbine engine of any preceding clause, wherein the gas turbine engine defines an engine centerline.

The gas turbine engine of any preceding clause, wherein the EGT is greater than 1000 degrees Celsius and less than 1300 degrees Celsius.

A method of operating the gas turbine engine of any preceding clause, the method comprising: operating the gas turbine engine at a takeoff power level.

A method of operating a gas turbine engine, the method comprising: operating the gas turbine engine at a takeoff power level; wherein the gas turbine engine is the gas turbine engine of any preceding clause.

A method of operating a gas turbine engine, comprising: operating the gas turbine engine at a takeoff power level, the gas turbine engine having a turbomachine with a high pressure compressor defining a high pressure compressor exit area (A_{HPCExit}) in square inches, the gas turbine engine defining a redline exhaust gas temperature (EGT) in degrees Celsius, a total sea level static thrust output (Fn_{Total}) in pounds, and a corrected specific thrust; wherein the turbine section and the compressor section define a core radius ratio (CRR), the CRR defined as a ratio of Rt/R_{INNER}, where Rt is a radius defined by a first turbine stage of the turbine section and R_{INNER} is a radius defined by a last compressor stage of the high pressure compressor, wherein the CRR is in a range of 0.9-1.3; and wherein the corrected specific thrust is greater than or equal to 42 and less than or equal to 90, the corrected specific thrust determined as follows: Fn_{Total}×EGT/(A_{HPCExit}²×1000).

A method of operating a gas turbine engine, comprising: operating the gas turbine engine at a takeoff power level, the gas turbine engine having a turbomachine with a high pressure compressor defining a high pressure compressor exit area (A_{HPCExit}) in square inches, the gas turbine engine defining a redline exhaust gas temperature (EGT) in degrees Celsius, a total sea level static thrust output (Fn_{Total}) in pounds, and a corrected specific thrust; wherein the gas turbine engine has a Nox Dp/Foo ratio (DPFR) defined as a ratio of a Nox Dp/Foo of a predecessor turbine engine to a Nox Dp/Foo of the gas turbine engine, wherein the DPFR is in a range of 0.8-2.0; and wherein the corrected specific thrust is greater than or equal to 42 and less than or equal to 90, the corrected specific thrust determined as follows: Fn_{Total}×EGT/(A_{HPCExit}²×1000).

A method of operating a gas turbine engine, comprising: operating the gas turbine engine at a takeoff power level, the gas turbine engine having a turbomachine with a high pressure compressor defining a high pressure compressor exit area (A_{HPCExit}) in square inches, the gas turbine engine defining a redline exhaust gas temperature (EGT) in degrees Celsius, a total sea level static thrust output (Fn_{Total}) in pounds, and a corrected specific thrust; the compressor section including a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60; and wherein the corrected specific thrust is greater than or equal to 42 and less than or equal to 90, the corrected specific thrust determined as follows:

$${Fn}_{Total} \times EGT / ( {A}_{HPCExit}^{2} \times 1000 ) .$$

What is claimed is:

1. A gas turbine engine comprising:
a turbomachine comprising a compressor section, a combustion section, and a turbine section arranged in serial flow order, the compressor section having a high pressure compressor defining a high pressure compressor exit area (A_{HPCExit}) in square inches;
wherein the turbine section and the compressor section define a core radius ratio (CRR), the CRR defined as a ratio of Rt/R_{INNER}, where Rt is a radius defined by a first turbine stage of the turbine section and R_{INNER} is a radius defined by a last compressor stage of the high pressure compressor, wherein the CRR is in a range of 0.9-1.3; and
wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

2. The gas turbine engine of claim 1, wherein the gas turbine engine has a Nox Dp/Foo ratio (DPFR) defined as a ratio of a Nox Dp/Foo of a predecessor turbine engine to a Nox Dp/Foo of the gas turbine engine, wherein the DPFR is in a range of 0.8-2.0.

3. The gas turbine engine of claim 2, wherein the turbomachine further comprises a fan section; and
wherein the compressor section includes a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60.

4. The gas turbine engine of claim 3, wherein the turbine section includes a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section.

5. The gas turbine engine of claim 4, wherein the first stage turbine nozzle has a solidity (G) defined as a ratio of a representative axial chord length for the first stage turbine nozzle to a representative circumferential spacing between adjacent vanes of the first stage turbine nozzle, wherein the solidity is in a range of 0.2-0.8.

6. The gas turbine engine of claim 5, wherein the first stage turbine nozzle has a durability and performance index (DPI) defined as:
$$DPI = \sqrt{[ \frac{CRR * DPFR}{σ} ]} * [ \frac{1.275 * N}{{OPR}^{0.275}} ] * [ 1 - 3 * {( σ - 0.6 )}^{2} ]$$
wherein the DPI is in the range of 1.001-2.201.

7. The gas turbine engine of claim 6, wherein:
1.217≤DPI≤2.201; and
N=2.

8. The gas turbine engine of claim 6, wherein:
1.001≤DPI≤1.1;
0.4≤σ≤0.6;
1.8≤DPFR≤2;
20≤OPR≤30;
1.0≤CRR≤1.2; and
1000≤EGT≤1300 degrees Celsius.

9. A gas turbine engine comprising:
a turbomachine comprising a compressor section, a combustion section, and a turbine section arranged in serial flow order, the compressor section having a high pressure compressor defining a high pressure compressor exit area (A_{HPCExit}) in square inches;
wherein the gas turbine engine has a Nox Dp/Foo ratio (DPFR) defined as a ratio of a Nox Dp/Foo of a predecessor turbine engine to a Nox Dp/Foo of the gas turbine engine, wherein the DPFR is in a range of 0.8-2.0; and
wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

10. The gas turbine engine of claim 9, wherein the turbomachine further comprises a fan section; and
wherein the compressor section includes a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60.

11. The gas turbine engine of claim 10, wherein the turbine section includes a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section.

12. The gas turbine engine of claim 11, wherein the first stage turbine nozzle has a solidity (σ) defined as a ratio of a representative axial chord length for the first stage turbine nozzle to a representative circumferential spacing between adjacent vanes of the first stage turbine nozzle, wherein the solidity is in a range of 0.2-0.8.

13. The gas turbine engine of claim 12, wherein:
0.4≤σ≤0.6;
1.8≤DPFR≤2; and
20≤OPR≤30; and
1000≤EGT≤1300 degrees Celsius.

14. The turbine engine of claim 9, wherein the Nox Dp/Foo of the gas turbine engine is less than the Nox Dp/Foo of the predecessor turbine engine.

15. A gas turbine engine comprising:
a turbomachine comprising a fan section, a compressor section, a combustion section, and a turbine section arranged in serial flow order, the compressor section having a high pressure compressor defining a high pressure compressor exit area (A_{HPCExit}) in square inches;
the compressor section including a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60; and
wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

16. The gas turbine engine of claim 15, wherein the turbomachine further comprises a fan section; and
wherein the compressor section includes a set of compressor stages, the set of compressor stages including a first compressor stage and a last compressor stage, each of the set of compressor stages comprising a pair of non-rotating vanes and rotating blades, wherein an overall pressure ratio (OPR) defined as a ratio of a total pressure immediately downstream of the last compressor stage to a total pressure immediately upstream of an inlet of the fan section, wherein the OPR is in a range of 20-60.

17. The gas turbine engine of claim 16, wherein the turbine section includes a set of turbine stages having a number of turbine stages (N) in a range of 1-2, each turbine stage comprising pairs of non-rotating vanes and rotating blades, wherein a set of vanes defines a nozzle, and wherein a first stage turbine nozzle is closest to the combustion section.

18. The gas turbine engine of claim 17, wherein the first stage turbine nozzle has a solidity (σ) defined as a ratio of a representative axial chord length for the first stage turbine nozzle to a representative circumferential spacing between adjacent vanes of the first stage turbine nozzle, wherein the solidity is in a range of 0.2-0.8; and
wherein the turbine section and the compressor section define a core radius ratio (CRR), the CRR defined as a ratio of Rt/R_{INNER}, where Rt is a radius defined by a first turbine stage of the turbine section and R_{INNER} is a radius defined by a last compressor stage of the high pressure compressor, wherein the CRR is in a range of 0.9-1.3.

19. The gas turbine engine of claim 15, wherein the EGT is greater than 1000 degrees Celsius and less than 1300 degrees Celsius.

20. The gas turbine engine of claim 15, wherein the turbine section and the compressor section define a core radius ratio (CRR), the CRR defined as a ratio of Rt/R_{INNER}, where Rt is a radius defined by a first turbine stage of the turbine section and R_{INNER} is a radius defined by a last compressor stage of the high pressure compressor, wherein the CRR is in a range of 0.9-1.3; and
wherein the first stage turbine nozzle has a solidity (σ) defined as a ratio of a representative axial chord length for the first stage turbine nozzle to a representative circumferential spacing between adjacent vanes of the first stage turbine nozzle, wherein the solidity is in a range of 0.2-0.8.
